(19) United States
(12) Patent Application Publication
(10) Pub. No.: US 2013/0016329 A1
(43) Pub. Date: Jan. 17, 2013

(54) EXPOSURE APPARATUS, EXPOSURE METHOD, MEASUREMENT METHOD, AND DEVICE MANUFACTURING METHOD

(71) Applicant: Akikazu TANIMOTO, Yokohama-shi (JP)

(72) Inventor: Akikazu TANIMOTO, Yokohama-shi (JP)

(73) Assignee: NIKON CORPORATION, Tokyo (JP)

(21) Appl. No.: 13/545,395

(22) Filed: Jul. 10, 2012

Related U.S. Application Data
(60) Provisional application No. 61/506,826, filed on Jul. 12, 2011.
(60) Provisional application No. 61/506,825, filed on Jul. 12, 2011.

(51) Int. Cl. G03B 27/42

(52) U.S. Cl. 355/53

(57) ABSTRACT

An exposure apparatus includes: an optical member which has an emission surface and in which a liquid immersion space is formed; a measurement member has a conductive first film and an upper surface, the upper surface includes a first portion and a second portion, the first portion being capable of facing the emission surface and being irradiated with measurement light, and the second portion includes a surface of a third film which is more liquid-repellent than the first film; a liquid immersion member, which is capable to be disposed to face the measurement member and which is capable of holding liquid between the measurement member; and a voltage adjustment apparatus that applies a voltage to at least one of the first film and the liquid immersion member, when at least a portion of an interface of the liquid of the liquid immersion space is located at the second portion.

### CROSS-REFERENCE TO RELATED APPLICATION

This application is a non-provisional application claiming priority to and the benefit of U.S. provisional application No. 61/506,825, filed Jul. 12, 2011, and U.S. Provisional Application No. 61/506,826 filed on Jul. 12, 2011. The entire contents of each of the applications identified above are incorporated herein by reference.

### BACKGROUND

1. Field of the Invention

The present invention relates to an exposure apparatus, an exposure method, a measurement method, and a device manufacturing method.

2. Description of Related Art

In exposure apparatuses used for photolithography processes, liquid immersion exposure apparatuses that expose a substrate with exposure light through liquid are contrived. U.S. Patent Application Publication No. 2007/242,242 discloses an example of a technique regarding a liquid immersion exposure apparatus including a measurement member.

### SUMMARY

When a measurement member deteriorates, there is a possibility that the accuracy of measurement using the measurement member is reduced. For example, when the measurement member includes an opening for measurement (pattern), there is a possibility that a change in the shape of the opening will cause the accuracy of measurement using the measurement member to be reduced. When an exposure is performed based on the result of the measurement using the measurement member, there is a possibility that a reduction in the accuracy of measurement causes a defective exposure to be generated and causes a defective device to be generated.

An object of an aspect of the present invention is to provide an exposure apparatus, an exposure method, and a measurement method which are capable of suppressing the generation of a defective exposure. In addition, another object of an aspect of the present invention is to provide a device manufacturing method which suppresses the generation of a defective device.

According to a first aspect of the present invention, there is provided an exposure apparatus that exposes a substrate with exposure light through liquid, including: an optical member which has an emission surface from which the exposure light is emitted, and in which a liquid immersion space of the liquid is formed at the emission surface side; a measurement member that has a conductive first film and an upper surface, the conductive first film being irradiated with measurement light, the upper surface including a first portion and a second portion, the first portion being capable of facing the emission surface and being irradiated with measurement light, and the second portion including a surface of a third film which is disposed in at least a portion of a periphery of the first portion and which is more liquid-repellent to the liquid than the first film; a liquid immersion member which is disposed so as to be capable of facing the measurement member in at least a portion of a periphery of the optical member and which is capable of holding liquid in between with the measurement member; and a voltage adjustment apparatus that applies a voltage to at least one of the first film and the liquid immersion member, when at least a portion of an interface of the liquid of the liquid immersion space is located at the second portion.

According to a second aspect of the present invention, there is provided an exposure apparatus that exposes a substrate with exposure light through liquid, including: an optical member having an emission surface from which the exposure light is emitted; a measurement member which is capable of being disposed at an area which is irradiated with the exposure light emitted from the emission surface, and which has a conductive first film and an insulating second film, the conductive first film being irradiated with measurement light and the insulating second film being disposed so as to cover at least a portion of the first film; and a voltage adjustment apparatus that applies a voltage to the first film.

According to a third aspect of the present invention, there is provided an exposure apparatus that exposes a substrate with exposure light through liquid, including: an optical member which has an emission surface from which the exposure light is emitted, and in which a liquid immersion space of the liquid is formed at the emission surface side; a measurement member having a conductive first film which is irradiated with measurement light; a liquid immersion member which is disposed so as to be capable of facing the measurement member in at least a portion of the periphery of the optical member and which is capable of holding liquid in between with the measurement member; and a voltage adjustment apparatus that applies a voltage to the liquid immersion member.

According to a fourth aspect of the present invention, there is provided a device manufacturing method including: exposing a substrate using the exposure apparatus according to any one of the first to third aspects; and developing the exposed substrate.

According to a fifth aspect of the present invention, there is provided an exposure method of exposing a substrate with exposure light through liquid, including: moving a measurement member with respect to an area which is irradiated with the exposure light emitted from an emission surface of an optical member from which the exposure light is emitted, the measurement member having a conductive first film and an upper surface, the conductive first film being irradiated with measurement light, the upper surface including a first portion and a second portion, the first portion being capable of facing the emission surface and being irradiated with the measurement light, and the second portion including a surface of a third film which is disposed in a periphery of the first portion and which is more liquid-repellent to the liquid than the first film; applying a voltage to at least one of the first film and the liquid immersion member when at least a portion of an interface of liquid of a liquid immersion space is located at the second portion; and exposing the substrate through the liquid immersion space of the liquid formed at the emission surface side, based on a result of the measurement using the measurement member.

According to a sixth aspect of the present invention, there is provided an exposure method of exposing a substrate with exposure light through liquid, including: irradiating a measurement light to a conductive first film of a measurement member which is capable of being disposed at an area which is irradiated with the exposure light emitted from an emission surface of an optical member, the measurement member having an insulating second film which is disposed so as to cover at least a portion of the first film; applying a voltage to the first film; and exposing the substrate through a liquid immersion space of the liquid which is formed at the emission surface side, based on a result of the measurement using the measurement member.

According to a seventh aspect of the present invention, there is provided an exposure method of exposing a substrate with exposure light through liquid, including: irradiating a measurement light to a conductive first film of a measurement member which is capable of being disposed at an area which is irradiated with the exposure light emitted from an emission surface of an optical member; applying a voltage to a liquid immersion member which is disposed so as to be capable of facing the measurement member in at least a portion of a periphery of the optical member and which is capable of holding liquid in between with the measurement member; and exposing the substrate through a liquid immersion space of the liquid which is formed at the emission surface side, based on a result of the measurement using the measurement member.

According to an eighth aspect of the present invention, there is provided a device manufacturing method including: exposing a substrate suing the exposure method according to any one of the fifth to seventh aspects; and developing the exposed substrate.

According to a ninth aspect of the present invention, there is provided an exposure apparatus that exposes a substrate with exposure light through liquid, including: an optical member which has an emission surface from which the exposure light is emitted, and under which a liquid immersion space of the liquid is formed at an emission surface side; a measurement member which is capable of being disposed at an area which is irradiated with the exposure light emitted from the emission surface and which has a conductive first film which is irradiated with measurement light; a liquid immersion member which is disposed so as to be capable of facing the measurement member in at least a portion of a periphery of the optical member and which is capable of holding liquid in between with the measurement member; and a voltage adjustment apparatus that applies a voltage to at least one of the first film and the liquid immersion member so as to suppress emission of photoelectrons from the first film caused by the measurement light irradiation.

According to a tenth aspect of the present invention, there is provided a device manufacturing method including; exposing a substrate using the exposure apparatus according to any one of the ninth aspect; and developing the exposed substrate.

According to an eleventh aspect of the present invention, there is provided an measurement method used in an exposure apparatus that exposes a substrate with exposure light through liquid, including: irradiating a measurement light to a conductive first film of a measurement member which is capable of being disposed at an area which is irradiated with the exposure light emitted from an emission surface of an optical member; and applying a voltage to at least one of a first film and a liquid immersion member so as to suppress emission of photoelectrons from the first film caused by the measurement light irradiation, the liquid immersion member being disposed so as to be capable of facing the measurement member in at least a portion of the periphery of the optical member and to be capable of holding liquid in between with the measurement member.

According to a twelfth aspect of the present invention, there is provided a device manufacturing method including: exposing the substrate through a liquid immersion space of the liquid which is formed at the emission surface side, based on a result of the measurement using the measurement method according to the eleventh aspect; and developing the exposed substrate.

According to the aspects of the present invention, it is possible to suppress the generation of a defective exposure. In addition, according to aspects of the present invention, it is possible to suppress the generation of a defective device.

### BRIEF DESCRIPTION OF THE DRAWINGS

FIG. 1 is a schematic configuration diagram illustrating an example of an exposure apparatus according to a first embodiment.

FIG. 2 is a cross-sectional side view illustrating an example of a measurement member according to the first embodiment.

FIG. 3 is a perspective view illustrating an example of a substrate stage and a measurement stage according to the first embodiment.

FIG. 4 is a diagram illustrating an example of the measurement member and a liquid immersion member according to the first embodiment.

FIG. 5 is a schematic diagram illustrating an example of a state of a measurement member and liquid according to a second embodiment.

FIG. 6 is a schematic diagram illustrating an example of a state of the measurement member and the liquid according to the second embodiment.

FIG. 7 is a diagram illustrating an example of the measurement member and a liquid immersion member according to the second embodiment.

FIG. 8 is a cross-sectional side view illustrating an example of the measurement member.

FIG. 9 is a schematic diagram illustrating an example a state where an object is irradiated with light.

FIG. 10 is a schematic diagram illustrating an example of a state where a measurement member according to a third embodiment is irradiated with exposure light.

FIG. 11 is a flow chart for explaining an example of a process of manufacturing a micro-device.

### DESCRIPTION OF EMBODIMENTS

Hereinafter, embodiments of the present invention will be described with reference to the drawings, but the present invention is not limited thereto. In the following description, an XYZ orthogonal coordinate system is set, and a positional relationship of each part will be described with reference to the XYZ orthogonal coordinate system. A predetermined direction within the horizontal plane is set to an X axial direction, a direction orthogonal to the X axial direction within the horizontal plane is set to a Y axial direction, and a direction (that is, vertical direction) orthogonal to the X axial direction and the Y axial direction is set to a Z axial direction. In addition, rotational (tilting) directions around the X-axis, the Y-axis, and the Z-axis are set to a θX direction, a θY direction, and a θZ direction, respectively.

### First Embodiment

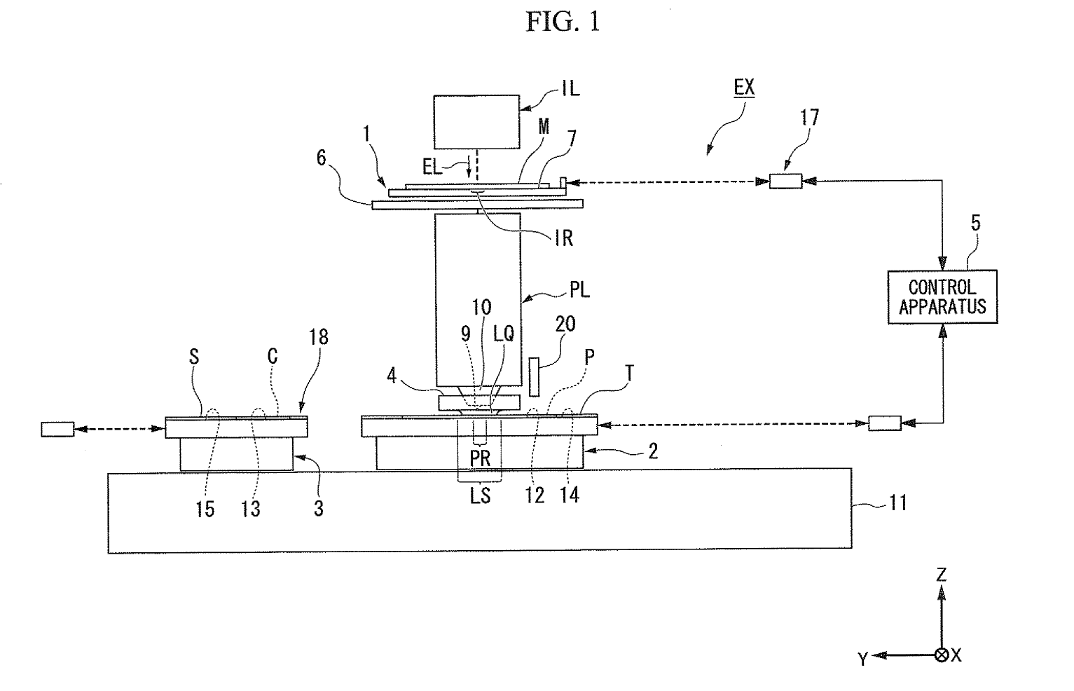

A first embodiment will be described below. FIG. 1 is a schematic configuration diagram illustrating an example of an exposure apparatus EX according to a first embodiment. The exposure apparatus EX according to the present embodiment is a liquid immersion exposure apparatus that exposes a substrate P with exposure light EL through liquid LQ. In addition, in the present embodiment, a description will be made, by way of example, of a case where the exposure apparatus EX is, for example, an exposure apparatus including a substrate stage and a measurement stage as disclosed in the U.S. Pat. No. 6,897,963, the EP Patent Application Publication No. 1,713,113, and the like.

In FIG. 1, the exposure apparatus EX includes a mask stage 1 that is movable while holding a mask M, a substrate stage 2 that is movable while holding the substrate P, a measurement stage 3 that is movable while holding a measurement member C and not holding the substrate P, an illumination system IL that illuminates the mask M with the exposure light EL, a projection optical system PL that projects an image of a pattern of the mask M, illuminated with the exposure light EL, onto the substrate P, a liquid immersion member 4 which is capable of forming a liquid immersion space LS so that a light path of the exposure light EL emitted from the projection optical system PL is filled with the liquid LQ, and a control apparatus 5 that controls a operation of the entire exposure apparatus EX.

The liquid immersion space is a space which is filled with liquid. In the present embodiment, water (pure water) is used as the liquid LQ. The mask M includes a reticle on which a device pattern projected onto the substrate P is formed. The substrate P is a substrate for manufacturing a device. The substrate P includes, for example, a semiconductor wafer and a film of a photosensitive material formed on the semiconductor wafer.

The illumination, system IL irradiates a predetermined illumination region IR with the exposure light EL. The illumination region IR includes a position which can be irradiated with the exposure light EL emitted from the illumination system IL. In the present embodiment, ArF excimer laser light is used as the exposure light EL emitted from the illumination system IL. In addition, KrF excimer laser light may be used as the exposure light EL.

The mask stage 1 can move on a guide surface (upper surface) of a first surface plate 6. The mask stage 1 has a holding portion 7 that releasably holds the mask M. The mask stage 1 can move the mask M held in the holding portion 7 to a position which is capable of being irradiated with the exposure light EL emitted from the illumination system IL. The mask stage 1 can move by an operation of a drive system. The drive system includes a planar motor having a slider disposed in the mask stage 1 and a stator disposed in the first surface plate 6. In addition, an example of the planar motor is disclosed in, for example, the U.S. Pat. No. 6,452,292. The mask stage 1 can move on the guide surface of the first surface plate 6 in six directions (i.e., X-axis, Y-axis, Z-axis, θX, θy, and θZ) by the operation of the drive system.

The projection optical system PL irradiates a predetermined projection region PR with the exposure light EL. The projection optical system PL has an emission surface 9 for emitting the exposure light EL toward the image plane of the projection optical system PL. A last optical element 10 which is closest to the image plane of the projection optical system PL among a plurality of optical elements of the projection optical system PL has the emission surface 9. The liquid immersion space LS of the liquid LQ is formed at the emission surface 9 side. The projection region PR includes a position which is capable of being irradiated with the exposure light EL emitted from the emission surface 9. The projection optical system PL projects an image of a pattern of the mask M, at a predetermined projection magnification, onto at least a portion of the substrate P disposed in the projection region PR. In the present embodiment, the exposure light EL emitted from the emission surface 9 travels in the −Z direction.

The substrate stage 2 and the measurement stage 3 can move on the guide surface (upper surface) of a second surface plate 11. The substrate stage 2 has a holding portion 12 that releasably holds the substrate P. The substrate stage 2 can move to a position which is capable of being irradiated with the exposure light EL emitted from the emission surface 9. The measurement stage 3 has a holding portion 13 that releasably holds the measurement member C. The measurement stage 3 can move to a position which is capable of being irradiated with the exposure light EL emitted from the emission surface 9. The substrate stage 2 and the measurement stage 3 can move by art operation of a drive system. The drive system includes a planar motor having a slider disposed in the substrate stage 2, a slider disposed in the measurement stage 3, and a stator disposed in the second surface plate 11. In addition, an example of the planar motor is disclosed in, for example, the U.S. Pat. No. 6,452,292. The substrate stage 2 and the measurement stage 3 can move on the guide surface of the second surface plate 11 in six directions (i.e., X-axis, Y-axis, Z-axis, θX, θY, and θZ) by the operation of the drive system.

In the present embodiment, the substrate stage 2 is disposed in at least a portion of the periphery of the holding portion 12 as disclosed in the U.S. Patent Application Publication No. 2007/0,177,125, the U.S. Patent Application Publication No. 2008/0,049,209 and the like, and has a holding portion 14 that releasably holds a cover member T. The measurement stage 3 is disposed in at least a portion of the periphery of the holding portion 13, and has a holding portion 15 that releasably holds a cover member S.

The positions of the mask stage 1, the substrate stage 2, and the measurement stage 3 axe measured by an interferometer system 17. When an exposure process of the substrate P is performed, or when, a predetermined measurement process is performed, the control apparatus 5 brings the drive system into operation based on the measurement result of the interferometer system 17, and controls the positions of the mask stage 1 (mask M), the substrate stage 2 (substrate P), and the measurement stage 3 (measurement member C).

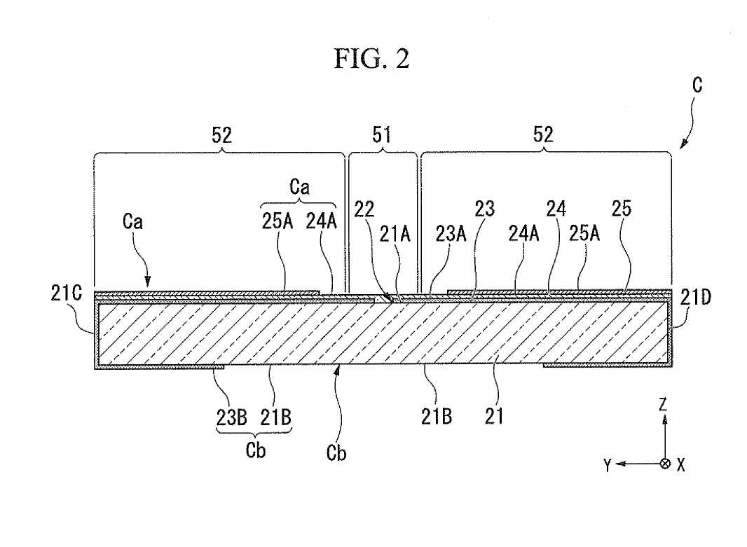

Next, the measurement member C will be described. FIG. 2 is a cross-sectional side view illustrating an example of the measurement member C according to the present embodiment.

In FIG. 2, the measurement member C has an upper surface Ca capable of facing the emission surface 9, and a lower surface Cb directed to the opposite direction of the upper surface Ca. The holding portion 13 holds at least a portion of the lower surface Cb. In the state where the measurement member C is held in the holding portion 13, the upper surface Ca is directed to the +Z direction. In the state where the measurement member C is held in the holding portion 13, the upper surface Ca can face the emission surface 9.

In the present embodiment, the measurement member C includes a base material 21 capable of transmitting measurement light, and a conductive first film 23 which is formed on the base material 21 and is irradiated with the measurement light. In addition, in the present embodiment, the measurement member C has a insulating second film 24 that covers at least a portion of the first film 23. In addition, in the present embodiment, the measurement member C has a liquid-repellent third film 25 that covers at least a portion of the second film 24.

In the present embodiment, the base material 21 is formed of quartz glass. The quartz glass can transmit the measurement light. In addition, the base material 21 may be formed of fluorite which is capable of transmitting the measurement light.

In the present embodiment, the base material 21 has a substantially rectangular parallelepiped shape. In FIG. 2, the base material 21 has an upper surface 21A directed to the +Z direction, a lower surface 21B directed to the −Z direction opposite to the upper surface 21A, and lateral sides 21C, 21D, 21E, and 21F which link the edge of the upper surface 21A to the edge of the lower surface 21B. The lateral side 21C is directed to the +Y direction. The lateral side 211) is directed to the −Y direction. The lateral side 21E is directed to the +X direction. The lateral side 21F is directed to the −X direction. In addition, in FIG. 2, the lateral sides 21E and 21F are not shown.

The first film 23 is conductive. The first film 23 has a light-shielding property with respect to the measurement light. That is, the first film 23 blocks passage of the measurement light. In addition, the first film 23 may completely block the measurement light with which the film is irradiated, and may not completely block the light. That is, transmittance of the first film 23 to the measurement light may be 0%, and the first film 23 may slightly transmit the measurement light insofar as the measurement light can be measured with a desired level of accuracy.

In the following description, the first film 23 is appropriately referred to as the light-shielding film 23.

In the present embodiment, the light-shielding film 23 is formed of chrome (Cr). In addition, the light-shielding film 23 may be formed of copper (Cu), may be formed of platinum (Pt), or may be formed of tantalum (Ta). Alternatively, the light-shielding film 23 may be formed of at least one of gold, palladium, rhodium, ruthenium, iridium, niobium, titanium, hafnium, zirconium, and nickel. Alternatively, the light-shielding film 23 may be formed of an alloy including at least one of chrome, platinum, tantalum, gold, palladium, rhodium, ruthenium, iridium, niobium, titanium, hafnium, zirconium, and nickel.

The light-shielding film 23 is disposed on at least a portion of the upper surface 21A of the base material 21. In addition, in the present embodiment, the light-shielding film 23 is disposed on at least a portion of the lateral sides 21C and 21D. In addition, the present embodiment, the light-shielding film 23 is disposed on at least a portion of the lower surface 21B. The light-shielding film 23 disposed on the upper surface 21A and the light-shielding film 23 disposed on the lateral sides 21C and 21D are connected to each other. The light-shielding film 23 disposed on the lateral sides 21C and 21D and the light-shielding film 23 disposed on the lower surface 21B are connected to each other. That is, in the present embodiment, the light-shielding film 23 disposed on the upper surface 21A and the light-shielding film 23 disposed on the lower surface 21B are electrically connected to each other through the light-shielding film 23 disposed on the lateral sides 21C and 21D.

In the present embodiment, the light-shielding film 23 comes into contact with, the surface (upper surface 21A, lower surface 21B, and lateral sides 21C, 21D, 21E, and 21F) of the base material 21. In addition, a separate film (interlayer) from the light-shielding film 23 may be disposed between the base material 21 and the light-shielding film 23.

In the present embodiment, the exposure apparatus EX includes a space image measurement system 18 which is capable of measuring a space image (imaging characteristic) of the projection optical system PL as disclosed in, for example, the U.S. Patent Application Publication No. 2002/0,041,377 and the like. In the present embodiment, the measurement member C constitutes a portion of the space image measurement system 18.

In the present embodiment, the measurement light includes the exposure light EL emitted from the emission surface 9 of the last optical element 10. That is, in the measurement using the measurement member C, the measurement member C is irradiated with the exposure light EL emitted from the emission surface 9.

In the present embodiment, the measurement member C has an opening 22 on which the exposure light EL can be incident. The light-shielding film 23 defines the opening 22.

The opening 22 is a portion which is not provided with the light-shielding film 23 on the upper surface 21A. In the present embodiment, the opening 22 is disposed in substantially the center of the upper surface 21A. In the present embodiment, the opening 22 within the XY plane parallel to the upper surface 21A has a slit shape formed long in the X-axis direction. In the present embodiment, a portion of the base material 21 is exposed at the inner side of the opening 22.

In the present embodiment, the measurement member C has the insulating second film 24 that covers at least a portion of the light-shielding film 23. It is more difficult for electricity to pass through the second film 24 than for the light-shielding film 23.

In the following description, the second film 24 is appropriately referred to as the insulating film 24.

In the present embodiment, the insulating film 24 is transmissive to the exposure light (measurement light) EL. That is, the exposure light (measurement light) EL can penetrate the insulating film 24.

In the present embodiment, the insulating film 24 includes silicon dioxide (SiO₂). In addition, the insulating film 24 may include fine particles made of magnesium fluoride (MgF₂) or calcium fluoride (CaF₂).

In the present embodiment, at least a portion of the insulating film 24 is disposed at the inner side of the opening 22. In the present embodiment, the insulating film 24 comes into contact with the upper surface 21A of the base material 21 at the inner side of the opening 22. In addition, the insulating film 24 is disposed so as to cover an upper surface 23A of the light-shielding film 23 which is directed to the +Z direction. In the present embodiment, the insulating film 24 comes into contact with the upper surface 23A of the light-shielding film 23. In addition, a separate film (interlayer) from the light-shielding film 23 and the insulating film 24 may be disposed between the light-shielding film 23 and the insulating film 24.

In the present embodiment, the measurement member C has the liquid-repellent third film 25 that covers at least a portion of the insulating film 24. It is more difficult for electricity to pass through the third film 25 than for the light-shielding film 23. In the present embodiment, the third film 25 is a film having an insulating property (insulating film).

In the following description, the third film 25 is appropriately referred to as the liquid-repellent film 25.

In the present embodiment, the liquid-repellent film 25 is liquid-repellent with respect to the liquid LQ. The contact angle of the surface of the liquid-repellent film 25 to the liquid. LQ is, for example, larger than 90 degrees.

In the present embodiment, an upper surface (surface) 25A of the liquid-repellent film 25 is more liquid-repellent to the liquid LQ than the light-shielding film 23. In addition, the upper surface (surface) 25A of the liquid-repellent film 25 has a higher liquid-repellent property for the liquid LQ than that of the insulating film 24.

In the present embodiment, the liquid-repellent film 25 includes fluorine. In the present embodiment, the liquid-repellent film 25 includes an amorphous fluorocarbon resin as disclosed in, for example, International Publication No. 2005/055,296.

The liquid-repellent film 25 is disposed in at least a portion of the periphery of the opening 22. In addition, the liquid-repellent film 25 is disposed so as to cover a portion of an upper surface 24A of the insulating film 24 which is directed to the +Z direction. In the present embodiment, the liquid-repellent film 25 comes into contact with the upper surface 24A of the insulating film 24. In addition, a separate film (interlayer) from the insulating film 24 and the liquid-repellent film 25 may be disposed between the insulating film 24 and the liquid-repellent film 25.

In the present embodiment, at least a portion of the upper surface Ca includes the upper surface 24A of the insulating film 24 which is directed to the +Z direction, in addition, in the present embodiment, at least a portion of the upper surface Ca includes the upper surface 25A of the liquid-repellent film 25 which is directed to the +Z direction. In the present embodiment, the light-shielding film 23 is not exposed and is not included in the upper surface Ca. That is, in the present embodiment, the light-shielding film 23 does not come into contact with the liquid LQ of the liquid immersion space LS.

In the present embodiment, the upper surface Ca of the measurement member C includes a first portion 51 on which the exposure light (measurement light) EL can be incident, and a second portion 52 located around the first portion 51.

In the present embodiment, the first portion 51 includes at least a portion of the upper surface 24A of the insulating film 24, and the second portion 52 includes at least a portion of the upper surface 25A of the liquid-repellent film 25. That is, the insulating film 24 is disposed in at least a portion of the first portion 51, and the liquid-repellent film 25 is disposed in at least a portion of the second portion 52. In the present embodiment, the first portion 51 does not include the upper surface 25A of the liquid-repellent film 25. In addition, a portion of the upper surface 25A of the liquid-repellent film 25 may be included in the first portion 51.

In the present embodiment, at least a portion of the lower surface Cb includes a lower surface 2313 of the light-shielding film 23 which is directed to the −Z direction. In addition, in the present embodiment, at least a portion of the lower surface Cb includes the lower surface 21B of the base material 21.

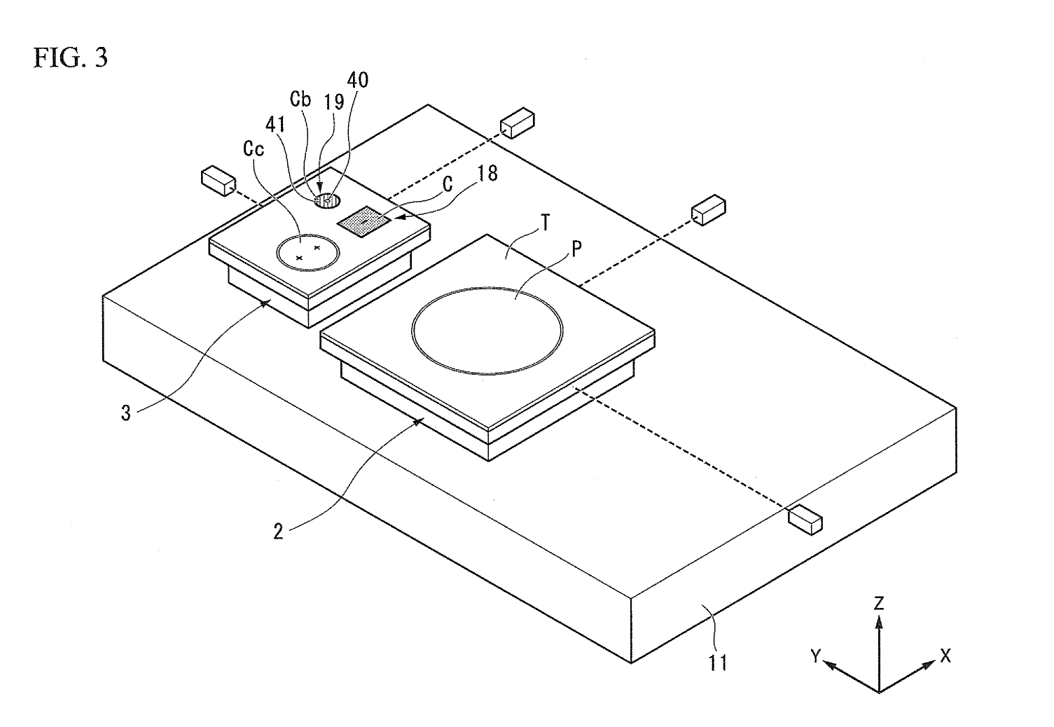

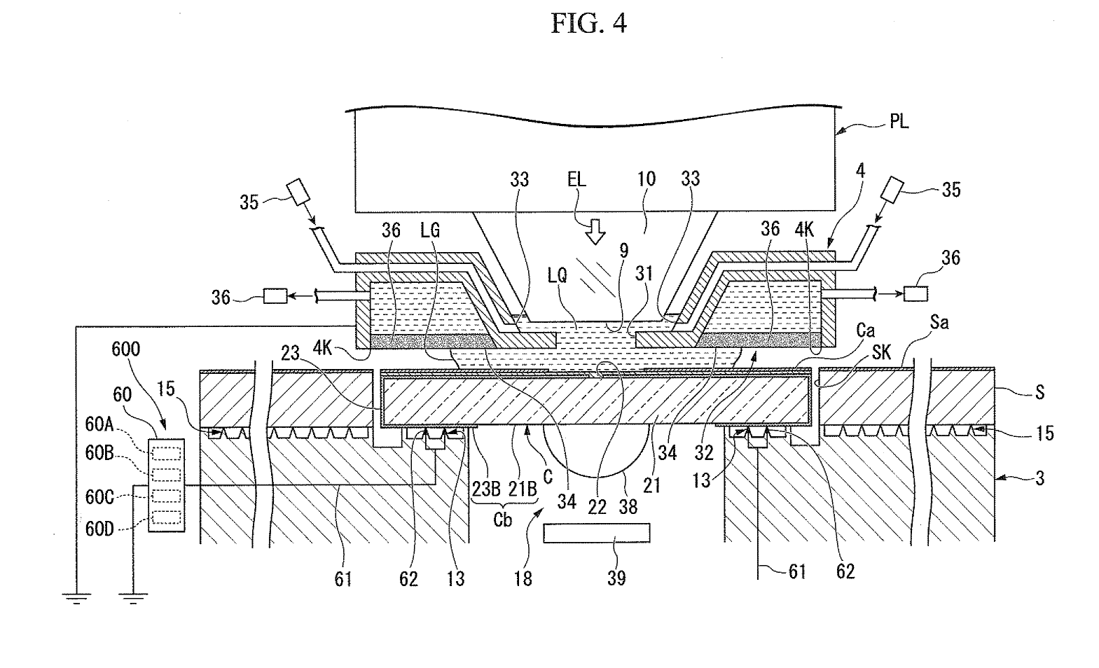

FIG. 3 is a perspective view illustrating an example of the substrate stage 2 and the measurement stage 3 according to the present embodiment, and FIG. 4 is a cross-sectional side view illustrating the vicinity of the measurement member C held in the holding portion 13.

In the present embodiment, the holding portion 13 includes a so-called pin chuck mechanism, and releasably holds the measurement member C. The holding portion 13 holds the measurement member C so that the upper surface Ca of the measurement member C is directed to the +Z direction. In the present embodiment, the holding portion 13 holds the measurement member C such that the upper surface Ca and the XY plane are substantially parallel to each other. The measurement member C is held in the holding portion 13, and thus the upper surface Ca can face the emission surface 9.

The holding portion 15 includes a so-called pin chuck mechanism, and releasably holds the cover member S. In the present embodiment, the holding portion 15 holds the cover member S so that an upper surface Sa of the cover member S and the XY plane are substantially parallel to each other. In the present embodiment, the upper surface Ca of the measurement member C held in the holding portion 13 and the upper surface Sa of the cover member S held in the holding portion 15 axe disposed in substantially the same plane (coplanar). In addition, at least a portion of the upper surface Sa may not be parallel to the XY plane, and may include a curved surface. In addition, at least a portion of the upper surface Ca may not be parallel to the XY plane, and may include a curved surface.

The measurement member C is held in the holding portion 13 and is disposed in the measurement stage 3. The cover member S held in the holding portion 15 is disposed in the periphery ate measurement member C held in the holding portion 13. The cover member S has an opening SK in which the measurement member C can be disposed. The measurement member C held in the holding portion 13 is disposed at the inner side of the opening SK of the cover member S held in the holding portion 15.

The measurement member C can be disposed in the position (projection region PR) which is capable of being irradiated with the exposure light EL emitted from the emission surface 9. In the present embodiment, the measurement member C is mounted to the movable measurement stage 3 with respect to the last optical element 10, and the position of the measurement stage 3 is adjusted, thereby allowing the measurement member C to be disposed in the position (projection region PR) which is capable of being irradiated with the exposure light emitted from the emission surface 9.

As shown in FIG. 4, in the present embodiment, the exposure apparatus EX includes a voltage system 600 that applies a voltage to an object. In the present embodiment, the voltage system 600 includes a voltage adjustment apparatus 60 and an interconnection 61 connected to the voltage adjustment apparatus 60.

The voltage adjustment apparatus 60 includes a power supply 60A, a first adjustment portion 60B capable of adjusting a value of the voltage applied to the object, a second adjustment portion 60C capable of adjusting the voltage applied to the object to at least one of positive and negative polarities, and a third adjustment portion 60D capable of adjusting the voltage (DC voltage) applied to the object.

In the present embodiment, the voltage system 600 applies a voltage to the light-shielding film 23. In the present embodiment, the voltage system 600 applies a DC voltage to the light-shielding film 23.

In the present embodiment, at least a portion of the voltage system 600 is disposed at the outside of the measurement stage 3. In addition, at least a portion of the voltage system 600 is provided in the measurement stage 3. In the present embodiment, a portion of the voltage adjustment apparatus 60 and the interconnection 61 is disposed at the outside of the measurement stage 3. The voltage adjustment apparatus 60 is earthed (grounded). A portion of the interconnection 61 is disposed in the measurement stage 3. The voltage adjustment apparatus 60 applies a voltage to the light-shielding film 23 through the interconnection 61.

In the present embodiment, the holding portion 13 includes a conductive portion 62 which is capable of being brought into contact with at least a portion of the light-shielding film 23 on the lower surface Cb. The conductive portion 62 is connected to the voltage adjustment apparatus 60 through the interconnection 61. The voltage adjustment apparatus 60 applies a voltage to the light-shielding film 23 which is brought into contact with the conductive portion 62 through the interconnection 61 and the conductive portion 62. That is in the present embodiment, the voltage adjustment apparatus 60 applies a voltage to the light-shielding film 23 through the conductive portion 62 provided in the measurement stage 3.

In addition, the entire measurement stage 3 including the holding portion 13 may be formed of an electric conductor. The voltage adjustment apparatus 60 may apply a voltage to the light-shielding film 23 through the measurement stage 3 of the electric conductor. In addition, the voltage system 600 may include the measurement stage 3.

The liquid immersion member 4 is disposed so as to be capable of facing the measurement member C in at least a portion of the periphery of the last optical element 10. In the present embodiment, the liquid immersion member 4 is earthed (grounded). The liquid immersion member 4 can hold the liquid LQ between the measurement member C and the liquid immersion member. The liquid immersion space LS is formed by the liquid LQ held between the last optical element 10 and the liquid immersion member 4, and the measurement member C so that the light path of the exposure light EL emitted from the emission surface 9 is filled with the liquid LQ. As shown in FIG. 4, in the present embodiment, the measurement member C is irradiated with the exposure light EL emitted from the emission surface 9 through the liquid LQ of the liquid immersion space LS.

The liquid immersion member 4 includes an opening 31 through which the exposure light EL emitted from the emission surface 9 can pass, and a lower surface 32, disposed in the periphery of the opening 31, which is capable of facing the upper surface Ca. The liquid immersion member 4 can hold the liquid LQ between the upper surface Ca facing the lower surface 32 and the liquid immersion member.

In addition, the liquid immersion member 4 includes a supply port 33 capable of supplying the liquid LQ and a recovery port 34 capable of recovering the liquid LQ. The supply port 33 can supply the liquid LQ between the last optical element 10 and the measurement member C. That is, the supply port 33 can supply the liquid LQ to the light path of the exposure light EL emitted from the emission surface 9. The liquid LQ supplied from the supply port 33 is supplied to the upper surface Ca of the measurement member C through the opening 31. In the present embodiment, the supply port 33 is disposed at a predetermined position of the liquid immersion member 4 so as to face the light path of the exposure light EL. The supply port 33 is connected to a liquid supply apparatus 35 through a supply channel. The liquid supply apparatus 35 can send out the liquid LQ. The supply port 33 supplies the liquid LQ, supplied from the liquid supply apparatus 35, to the light path of the exposure light EL.

The recovery port 34 can recover at least a portion of the liquid LQ on the measurement member C facing the lower surface 32. In the present embodiment, the recovery port 34 is disposed at a predetermined position of the liquid immersion member 4 so as to face the upper surface Ca. In the present embodiment, the liquid immersion member 4 has an opening 4K in which a porous member 36 is disposed. The porous member 36 has a plurality of holes (openings or pores) through which the liquid LQ can pass. In the present embodiment, the liquid LQ on the measurement member C is recovered through the holes of the porous member 36. That is in the present embodiment, the recovery port 34 includes the holes of the porous member 36. In the present embodiment, the porous member 36 is a plate-shaped member. In the present embodiment, the lower surface 32 includes a planar surface disposed in the periphery of the opening 31, and a lower surface of the porous member 36 disposed in the periphery of the planar surface. In addition, the porous member 36 may not be disposed in the opening 4K. For example, the opening 4K may function as a recovery port. The recovery port 34 is connected to a liquid recovery apparatus 37 through a recovery channel. The liquid recovery apparatus 37 includes a vacuum system, and can suction the liquid LQ. The liquid LQ recovered from the recovery port 34 is recovered in the liquid recovery apparatus 37.

In the present embodiment, the operation of recovering the liquid LQ from the recovery port 34 is performed concurrently with the operation of supplying the liquid LQ from the supply port 33, and thus the liquid immersion space LS is formed between the last optical element 10, and the liquid immersion member 4 and the measurement member C.

In addition, an object capable of holding the liquid LQ between the last optical element 10 and the liquid immersion member 4 and capable of forming the liquid immersion space LS is not limited to the measurement member C. The object capable of moving to the position facing the emission surface 9 and the position facing the lower surface 32 is able to hold the liquid LQ between the last optical element 10 and the liquid immersion member 4 and form the liquid immersion space LS. In the present embodiment, at least one of the cover member T (substrate stage 2), the substrate P held in the substrate stage 2, and the cover member S (measurement stage 3) is able to hold the liquid LQ between the last optical element 10 and the liquid immersion member 4 and form the liquid immersion space LS. For example, in the exposure of the substrate P, the liquid LQ is held between the last optical element 10, and the liquid immersion member 4 and the substrate P and the liquid immersion space LS is formed so that the light path of the exposure light EL emitted from the emission surface 9 is filled with the liquid LQ.

In the present embodiment, in the exposure apparatus EX, a local liquid immersion method is adopted. As shown in FIG. 4, an interface (a meniscus or an edge) LG of the liquid LQ of the liquid immersion space LS is formed between the lower surface 32 and the upper surface Ca. In addition, in the present embodiment, the size of the liquid immersion space LS within the XY plane is smaller than that of the measurement member C, but may be larger than that. For example, in the state where the liquid immersion space LS is formed so that the light path located between the emission surface 9 and the opening 22 is filled with the liquid LQ, the interface LG may be disposed between the lower surface 32 and the upper surface Sa.

Next, an example of a measurement process using the measurement member C will be described with reference to FIG. 4. When the measurement process using the measurement member C is performed, the control apparatus 5 disposes the measurement member C in the position facing the emission surface 9. The liquid LQ supplied from the supply port 33 is held between the emission surface 9, and the lower surface 32 and the measurement member C, and thus the liquid immersion space LS is formed. The liquid LQ of the liquid immersion space LS comes into contact with the emission surface 9, the lower surface 32, and the upper surface Ca.

In order to measure an space image (imaging characteristic) of the projection optical system PL using the space image measurement system 18 including the measurement member C, the control apparatus 5 emits the exposure light EL from the illumination system IL, and illuminates a pattern for measurement disposed at the object plane side of the projection optical system PL. The exposure light EL with which the pattern for measurement is irradiated and which passes through the projection optical system PL is emitted from the emission surface 9. At least a portion of the light-shielding film 23 of the measurement member C is irradiated with the exposure light EL emitted from the emission surface 9 through the liquid LQ of the liquid immersion space LS. In the present embodiment, the light-shielding film 23 is irradiated with the exposure light EL emitted from the emission surface 9 through the liquid LQ of the liquid immersion space LS and the insulating film 24.

In the present embodiment, the exposure light EL emitted from the emission surface 9 is incident on the first portion 51 in the upper surface Ca of the measurement member C, and is not incident on the second portion 52. That is, the insulating film 24 and the light-shielding film 23 are irradiated with the exposure light EL, and the liquid-repellent film 25 is not irradiated. In other words, the exposure light EL is incident on the light-shielding film 23 without transmitting through the liquid-repellent film 25.

At least a portion of the exposure light EL with which the first portion 51 is irradiated is incident on the opening 22. The exposure light EL which is incident on the opening 22 through the liquid LQ passes through the base material 21, and is emitted from the lower surface 21B. In the present embodiment, an optical element 38 of the space image measurement system 18 is disposed so as to come into contact with the lower surface 21B. The exposure light EL, emitted from the lower surface 21B, which passes through the optical element 38 is received in a light receiving element 39 of the space image measurement system 18. The control apparatus 5 seeks a space image (imaging characteristic) of the projection optical system PL through the liquid LQ, based on the light receiving result of the light receiving element 39.

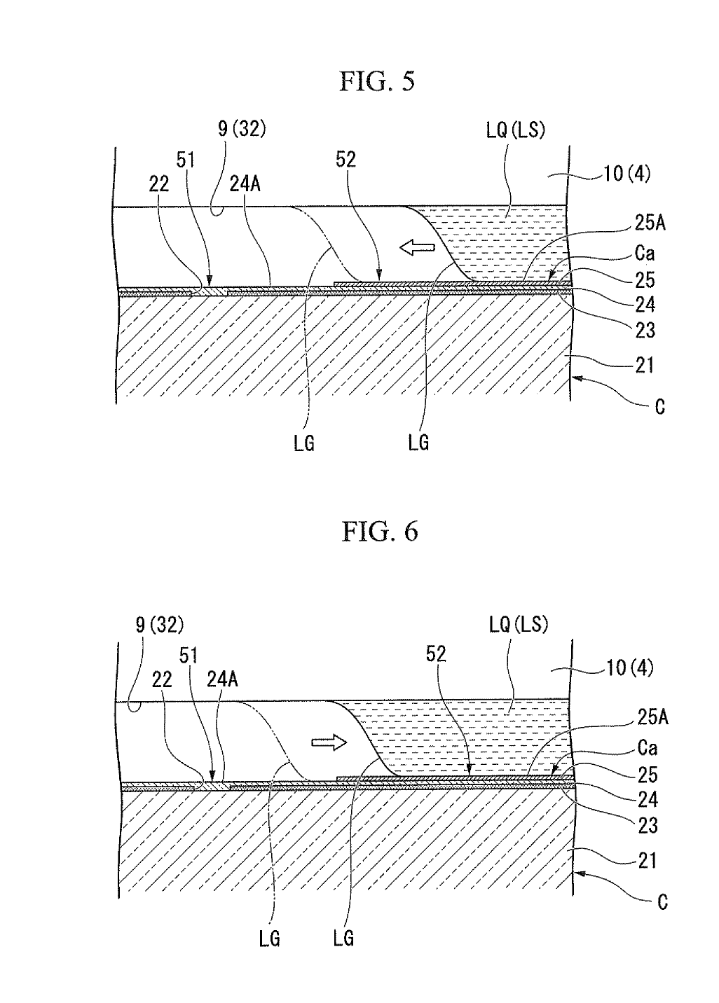

FIGS. 5 and 6 are diagrams illustrating an example of a state where the liquid immersion space LS of the liquid LQ is formed between the last optical element 10 and at least a portion of the measurement member C.

In the present embodiment, when at least a portion of the interface LG of the liquid LQ of the liquid immersion space LS is located at the second portion 52, the voltage adjustment apparatus 60 applies a voltage to the light-shielding film 23.

In the present embodiment, the measurement member C can form the liquid immersion space LS of the liquid LQ between the last optical element 10 and the liquid immersion member 4 facing each other, and moves within the X plane with respect to the last optical element 10 and the liquid immersion member 4 in the state where the liquid immersion space LS is formed. For example, when the measurement member C moves in the state where at least a portion of the interface LG of the liquid LQ of the liquid immersion space LS is located at the second portion 52, the voltage adjustment apparatus 60 may apply a voltage to the light-shielding film 23. For example, the voltage adjustment apparatus 60 may adjust the voltage applied to the light-shielding film 23, in accordance with movement conditions of the measurement member C.

In the present embodiment, the position of the measurement stage 3 is measured by the interferometer system 17. The interferometer system 17 irradiates an interferometer mirror included in the measurement stage 3 with detection light, and seeks the position of the measurement stage 3. The position relationship between the interferometer mirror included in the measurement stage 3 and the measurement member C mounted on the measurement stage 3 is well-known. In addition, the position relationship between the interferometer mirror and the first and second portions 51 and 52 of the measurement member C is well-known. Therefore, the control apparatus 5 can seek the position of the measurement member C (first and second portions 51 and 52) within the coordinate system of the interferometer system 17, based on the measurement result of the interferometer system 17.

In addition, the position of the interface LG within the coordinate system of the interferometer system 17 when the object moves in the state where the liquid immersion space LS is formed between the last optical element 10, and the liquid immersion member 4 and the object such as the measurement stage 3 is predictable or well-known. For example, the position of the interface LG depends on the structure of the liquid immersion member 4 such as the position, the size, and the shape of the recovery port 34 within the lower surface of the liquid immersion member 4. In addition, there is also a possibility that the position of the interface LG depends on liquid immersion conditions including the amount of liquid supplied per unit time from the supply port 33 and the amount of liquid recovered per unit time from the recovery port 34. In addition, there is also a possibility that the position of the interface LG depends on movement conditions (movement velocity, acceleration, continuous movement distance regarding a certain direction; movement locus, and the like) of the object in the state where the liquid immersion space LS is formed. For example, the position of the interface LG determined based on at least one of the structure of the liquid immersion member 4, the liquid immersion conditions, and the movement conditions can be sought by preliminary experiments or simulations.

Therefore, the control apparatus 5 can seek the position relationship between the measurement member C (first and second portions 51 and 52) and the interface LG within the coordinate system of the interferometer system 17, based on the measurement result or the like of the interferometer system 17. In the present embodiment, the control apparatus 5 can adjust the voltage adjustment apparatus 60 based on the position relationship between the measurement member C (first and second portions 51 and 52) and the interface LG.

FIG. 5 shows an example of the state where the measurement member C moves so that the interface LG of the liquid LQ of the liquid immersion space LS moves from the second portion 52 on the upper surface Ca of the measurement member C to the first portion 51. FIG. 6 shows an example of the state where the measurement member C moves so that the interface LG of the liquid LQ of the liquid immersion space LS moves from the first portion 51 on the upper surface Ca of the measurement member C to the second portion 52.

In the present embodiment, the second portion 52 includes the upper surface 25A of the liquid-repellent film 25. The first portion 51 includes the upper surface 24A of the insulating film 24.

In the following description, the movement condition of the measurement member C when the interface LG of the liquid LQ of the liquid immersion space LS is moved from the second portion 52 of the upper surface Ca to the first portion 51 is appropriately referred to as a first movement condition, and the movement condition of the measurement member C when the interface thereof is moved from the first portion 51 to the second portion 52 is appropriately referred to as a second movement condition.

When the liquid immersion space LS of the liquid LQ is formed between the last optical element 10 and the liquid immersion member 4, and at least a portion of the measurement member C, and at least a portion of the interface LG of the liquid LQ of the liquid immersion space LS is located at the second portion 52, there is a possibility of charges being generated and accumulated in the light-shielding film 23. For example, there is a possibility of charge being generated by the contact of the liquid LQ with the second portion 52 (upper surface 25A of the liquid-repellent film 25).

In addition, when the measurement member C moves in the state where the liquid immersion space LS of the liquid LQ is formed between the last optical element 10, and the liquid immersion member 4 and at least a portion of the measurement member C, there is a possibility of charges being generated and accumulated in the light-shielding film 23. That is, when the measurement member C moves in the state where the liquid LQ of the liquid immersion space LS and at least a portion of the upper surface Ca of the measurement member C are in contact with each other, there is a possibility of the light-shielding film 23 being charged. For example, when at least a portion of the interface LG of the liquid LQ of the liquid immersion space LS moves on the liquid-repellent film 25, there is a possibility of charges being generated and accumulated in the light-shielding film 23.

In addition, when the interface LG of the liquid LQ of the liquid immersion space LS is located at the second portion 52, or when the measurement member C moves in the state where the liquid LQ of the liquid immersion space LS and at least a portion of the upper surface Ca of the measurement member C are in contact with each other, there is a possibility of charges being generated even in the case where the measurement member C is not only irradiated with the exposure light EL but also is not irradiated.

When a state in which the light-shielding film 23 is charged is left as it is, there is a possibility of at least a portion of the light-shielding film 23 being damaged due to, for example, electrical discharge. There is a possibility of the light-shielding film 23 being deteriorated, such as, for example, a case where the shape of the opening 22 changes, or a case where light transmission holes are present in a portion of the light-shielding film 23. As a result, there is a possibility of the accuracy of measurement using the measurement member C being reduced.

For example, when the interface LG of the liquid LQ of the liquid immersion space LS moves onto the liquid-repellent film 25, there is a possibility of the potential difference being generated in the liquid LQ of the liquid immersion space LS and the light-shielding film 23. When the interface LG of the liquid LQ of the liquid immersion space LS moves onto the liquid-repellent film 25, there is a possibility of the potential difference being generated in the portion (including at least one of the liquid immersion member 4 and the liquid-repellent film 25) which is in contact with the liquid LQ of the liquid immersion space LS and the light-shielding film 23. As a result, there is a possibility of at least a portion of the light-shielding film 23 being electrostatically destructed.

For example, in the first movement condition shown in FIG. 5, there is a possibility of a current flowing from the lower surface 32 of the liquid immersion member 4 toward the upper surface Ca, in at least a portion of the liquid LQ in the vicinity of the interface LG. In addition, in the second movement condition shown in FIG. 6, there is a possibility of a current flowing, for example, from the upper surface Ca toward the lower surface 32 of the liquid immersion member 4, in at least a portion of the liquid LQ in the vicinity of the interface LG.

When a current flows in the liquid LQ, there is a possibility of the potential difference between at least a portion of the liquid LQ, for example, in the vicinity of the interface LG and the light-shielding film 23 increasing.

In this manner, when the potential difference is generated between the liquid LQ of the liquid immersion space LS and the light-shielding film 23 and the potential difference increases, there is a possibility of at least a portion of the light-shielding film 23 being electrostatically destructed. That is, when a portion having a high potential difference with the light-shielding film 23 is generated in the liquid LQ of the liquid immersion space LS, there is a possibility of at least a portion of the light-shielding film 23 being electrostatically destructed.

For this reason, when at least the interface LG of the liquid LQ is located at the second portion 52, a voltage is applied to the light-shielding film 23 so that the potential difference between at least a portion of the liquid LQ and the light-shielding film 23 decreases, thereby allowing deterioration (electrostatic destruction) of the light-shielding film 23 to be suppressed.

In the present embodiment, the voltage adjustment apparatus 60 may switch polarities of the voltage applied to the light-shielding film 23 in the first movement condition and the second movement condition. In other words, a first voltage applied to the light-shielding film 23 when the measurement member C moves in the first movement condition and a second voltage applied to the light-shielding film 23 when the measurement member C moves in the second movement condition may be different from each other in polarity.

In the present embodiment, the voltage adjustment apparatus 60 applies a negative voltage to the light-shielding film 23 in the first movement condition shown in FIG. 5. In addition, the voltage adjustment apparatus 60 applies a positive voltage to the light-shielding film 23 in the second movement condition shown in FIG. 6. Thereby, the potential difference between a portion of the liquid LQ in the vicinity of the interface LG and the light-shielding film 23 decreases. Thereby, the deterioration (electrostatic destruction) of the light-shielding film 23 is suppressed, and a decrease in the accuracy of measurement using the measurement member C is suppressed. In addition, the magnitude (absolute value) of the first voltage in the first movement condition and the magnitude (absolute value) of the second voltage in the second movement condition may be the same as each other. The magnitude (absolute value) of the first voltage may be larger than the magnitude (absolute value) of the second voltage, and may be smaller than that.

In addition, when there is a possibility that the potential difference between the portion which is in contact with the liquid LQ and the light-shielding film 23 causes electrical discharge, a voltage may be applied to the light-shielding film 23 so that the potential difference decreases. In this case, a negative voltage may be applied to the light-shielding film 23 in the first movement condition shown in FIG. 5, and a positive voltage may be applied to the light-shielding film 23 in the second movement condition shown in FIG. 6. A positive voltage may be applied to the light-shielding film 23 in the first movement condition, and a negative voltage may be applied to the light-shielding film 23 in the second movement condition.

In the present embodiment, the voltage adjustment apparatus 60 may adjust the magnitude (absolute value) of the voltage applied to the light-shielding film 23, in accordance with the movement velocity of the measurement member C with respect to the last optical element 10. For example, the magnitude of the voltage applied to the light-shielding film 23 when the measurement member C moves at a first velocity and the magnitude of the voltage applied to the light-shielding film 23 when the measurement member C moves at a second velocity may be changed. For example, when the movement velocity of the measurement member C in the first movement condition is different from the movement velocity of the measurement member C in the second movement condition, the voltage adjustment apparatus 60 may perform an adjustment so that the magnitude of the first voltage in the first condition and the magnitude of the second voltage in the second movement condition are different from each other.

For example, there is a possibility that at least one of the potential difference between the liquid LQ and the light-shielding film 23 and the potential difference between the portion which is in contact with the liquid LQ and the light-shielding film 23 changes due to the movement velocity of the interface LG to the upper surface Ca. For this reason, the magnitude of the voltage applied to the light-shielding film 23 is adjusted in accordance with the movement velocity of the measurement member C so that the at least one potential difference decreases, thereby allowing the deterioration of the light-shielding film 23 to be suppressed. For example, the voltage adjustment apparatus 60 may apply the first voltage to the light-shielding film 23 when the measurement member C moves at a first movement velocity, and the voltage adjustment apparatus 60 may apply the second voltage having a larger absolute value than that of the first voltage to the light-shielding film 23 when the measurement member C moves at a second movement velocity higher than the first movement velocity.

In addition, when there is a possibility that the potential difference generated between the light-shielding film 23 and the film which does not come into contact with the liquid LQ on the light-shielding film 23 causes electrical discharge, a voltage may be applied to the light-shielding film 23 in consideration of the potential difference.

In addition, in the present embodiment, the voltage adjustment apparatus 60 may apply a voltage to the light-shielding film 23 in the state where the measurement member C is substantially at a standstill with respect to the liquid immersion space LS (liquid immersion member 4).

Next, a description will be made of an example of the operation of the exposure apparatus EX including a liquid immersion exposure process of the substrate P.

After the opening 22 of the measurement member C is irradiated with the exposure light EL and the measurement using the measurement member C is terminated, the control apparatus 5 starts an exposure of the substrate P. The control apparatus 5 illuminates the mask M with the exposure light EL emitted from the illumination system IL, in the state where the liquid immersion space LS is formed so that the light path of the exposure light EL between the last optical element 10 and the substrate P is filled with the liquid LQ. The exposure light EL through the mask M illuminates the projection optical system PL and the liquid LQ of the liquid immersion space LS. The exposure light EL passing through the mask M and the projection optical system PL is emitted from the emission surface 9. The substrate P is irradiated with the exposure light EL emitted from the emission surface 9 through the liquid LQ of the liquid immersion space LS. Thereby, an image of a pattern of the mask M is projected onto the substrate P, and the substrate P is exposed with the exposure light EL.

The exposure apparatus EX according to the present embodiment is a scanning-type exposure apparatus (so-called scanning stepper) that projects an image of a pattern of the mask M onto the substrate P while synchronously moving the mask M and the substrate P in a predetermined scanning direction. In the present embodiment, the scanning direction (synchronous movement direction) of the substrate P is set to a Y-axis direction, and the scanning direction (synchronous movement direction) of the mask M is also set to a Y-axis direction. The control apparatus 5 irradiates the substrate P with the exposure light EL through the projection optical system PL and the liquid LQ to expose the substrate P, while moving the substrate P in the Y-axis direction with respect to the projection region PR of the projection optical system PL, and moving the mask M in the Y-axis direction with respect to the illumination region IR of the illumination system IL in synchronization with the movement of the substrate P in the Y-axis direction.

In the present embodiment, the control apparatus 5 exposes the substrate P through the liquid LQ of the liquid immersion space LS formed at the emission surface 9 side, based on the measurement result using the measurement member C. For example, the control apparatus 5 adjusts exposure conditions based on the measurement result of the space image of the projection optical system PL measured using the measurement member C, and exposes the substrate P in the adjusted exposure conditions. The exposure conditions includes, for example, at least one of irradiation conditions of the exposure light EL and the movement conditions of the substrate stage 2 (substrate P) for the projection region PR.

As described above, according to the present embodiment, when at least the interface LG of the liquid LQ of the liquid immersion space LS is located at the second portion 52, a voltage is applied to the light-shielding film 23, and thus it is possible to suppress the deterioration of the light-shielding film 23, a change in the shape of the opening 22 defined by the light-shielding film 23, or the like. Therefore, it is possible to suppress a decrease in the accuracy of measurement using the measurement member C, and to suppress the generation of a defective exposure and the generation of a defective device.

In addition, as shown in FIG. 3, a voltage may be applied to measurement members Cb and Cc disposed in the measurement stage 3. In the present embodiment, the measurement member Cb constitutes a portion of an illuminance unevenness measurement system 19 capable of measuring illuminance unevenness of the exposure light EL as disclosed in, for example, U.S. Pat. No. 4,465,368 and the like. The measurement member Cc has a reference mark measured by an alignment system 20 capable of measuring an alignment mark of the substrate P as disclosed in, for example, the U.S. Pat. No. 5,493,403 and the like. In addition, the measurement member Cb may constitute a portion of a measurement system that measures the exposure light EL of the exposure light EL, such as an irradiance measurement system (illuminance measurement system) as disclosed in for example, the U.S. Patent Application Publication No. 2002/0,061,469 and the like, and a wavefront aberration measurement system as disclosed in, for example, the EP Patent No. 1,079,223 and the like.

In the present embodiment, the shape of the measurement member Cb within the XY plane is substantially circular. The measurement member Cb includes a base material capable of transmitting the exposure light EL, and a conductive light-shielding film 41 defining an opening 40, formed in the base material, on which the exposure light EL can be incident through the liquid LQ. In the present embodiment, the opening 40 is substantially circular. When the measurement member Cb has an insulating (liquid-repellent) film, and at least the interface LG of the liquid LQ of the liquid immersion space LS is located at the upper surface of the film, a voltage is applied to the light-shielding film 41, thereby allowing the deterioration of the light-shielding film 41, deformation of the opening 40 and the like to be suppressed.

In addition, in the above-mentioned embodiment, the liquid immersion member 4 may not be grounded.

### Second Embodiment

Next, a second embodiment will be described. In the following description, the same reference signs and numerals are given to the same components as those of the above-mentioned embodiment, and the description will be simplified or omitted.

In the present embodiment, an example will be described in which a voltage adjustment apparatus 70 applies a voltage to the liquid immersion member 4. The liquid immersion member 4 is conductive. At least a portion of the liquid immersion member 4 is made of metal, for example, such as titanium.

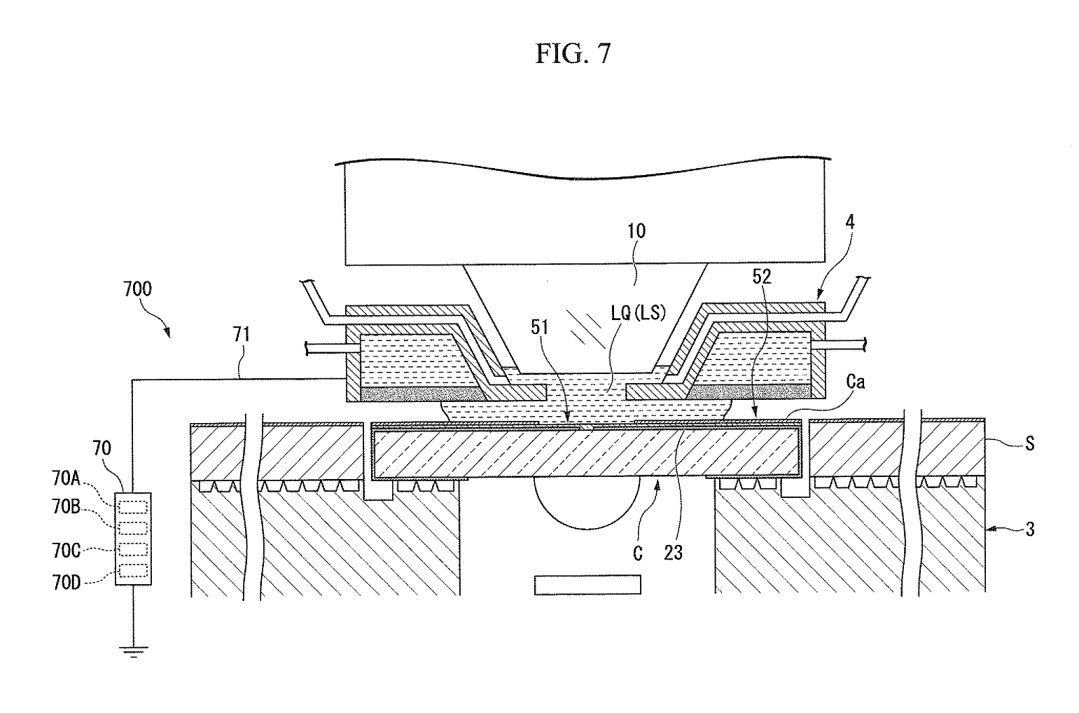

FIG. 7 is a diagram illustrating an example of an exposure apparatus EX according to a second embodiment. As shown in FIG. 7, the exposure apparatus EX includes a voltage system 700 that applies a voltage to the liquid immersion member 4. The voltage system 700 includes the voltage adjustment apparatus 70 and an interconnection 71 connected to the voltage adjustment apparatus 70.

The voltage adjustment apparatus 70 includes a power supply 70A, a first adjustment portion 7013 capable of adjusting a value of a voltage applied to the liquid immersion member 4, a second adjustment portion 70C capable of adjusting a voltage applied to an object to at least one of positive and negative polarities, and a third adjustment portion 70D capable of adjusting a voltage applied to (DC voltage) the object.

The voltage adjustment apparatus 70 is disposed at the outside of the liquid immersion member 4. The voltage adjustment apparatus 7015 earthed (grounded). The voltage adjustment apparatus 70 applies a voltage to the liquid immersion member 4 through the interconnection 71. The voltage adjustment apparatus 70 applies a DC voltage to the liquid immersion member 4.

In the present embodiment, the light-shielding film 23 is earthed (grounded).

When the liquid immersion member 4 and the measurement member C face each other, the voltage adjustment apparatus 70 applies a voltage to the liquid immersion member 4. In addition, when the liquid immersion member 4 and the measurement member C do not face each other, the voltage adjustment apparatus 70 may apply a voltage to the liquid immersion member 4.

For example, when at least a portion of the interface LG of the liquid LQ of the liquid immersion space LS is located at the second portion 52 of the measurement member C, the voltage adjustment apparatus 70 applies a voltage to the liquid immersion member 4. In addition, when at least a portion of the interface LG moves onto the second portion 52 (liquid-repellent film 25), the voltage adjustment apparatus 70 applies a voltage to the liquid immersion member 4. The voltage adjustment apparatus 70 may apply a voltage to the liquid immersion member 4 so that the potential difference between the liquid immersion member 4 and the light-shielding film 23 decreases. In addition, the voltage adjustment apparatus 70 may apply a voltage to the liquid immersion member 4 so as to suppress a flow of a current in the liquid LQ between the second portion 52 and the lower surface 32.

In addition, the voltage adjustment apparatus 70 may adjust the magnitude (absolute value) of the voltage applied to the liquid immersion member 4, in accordance with movement conditions of the measurement member C. For example, the voltage adjustment apparatus 70 may apply a first voltage to the liquid immersion member 7 when the measurement member C moves in a first movement condition, and may apply a second voltage to the liquid immersion member 7 when the measurement member C moves in a second movement condition. The first voltage and the second voltage may be different from each other in magnitude (absolute value), and may be the same as each other.

In addition, the first voltage and the second voltage may be different from each other in polarity. For example, the voltage adjustment apparatus 70 may switch polarities of the voltage applied to the liquid immersion member 4, in the first movement condition in which the interface LG of the liquid LQ of the liquid immersion space LS moves from the second portion 52 on the upper surface Ca to the first portion 51, and the second movement condition in which it moves from the first portion 51 to the second portion 52.

In addition, the movement velocity of the measurement member C in the first movement condition nay be different from the movement velocity of the measurement member C in the second movement condition, and may be the same as that. In addition, the voltage adjustment apparatus 70 may adjust the magnitude (absolute value) of the voltage applied to the liquid immersion member 4, in accordance with the velocity of the measurement member C to the last optical element 10 and the liquid immersion member 4. For example, when the movement velocity of the measurement member C in the first movement condition is greater than the movement velocity of the measurement member C in the second movement condition, the magnitude (absolute value) of the first voltage may be set to be larger than the magnitude (absolute value) of the second voltage, and may be set to be the same as that.

In addition, in the present embodiment, the voltage adjustment apparatus 70 may apply a voltage to the liquid immersion member 4 in the state where the measurement member C is substantially at a standstill with respect to the liquid immersion space LS (liquid immersion member 4).

In addition, in the present embodiment, the light-shielding film 23 may not be grounded. Alternatively, a voltage may be applied to the liquid immersion member 4 by the voltage adjustment apparatus 70, and a voltage may be applied to the light-shielding film 23 by the voltage adjustment apparatus 60. The control apparatus 5 may control at least one of the voltage adjustment apparatus 60 and the voltage adjustment apparatus 70, and may apply a voltage to one or both of the light-shielding film 23 and the liquid immersion member 4 so that the deterioration (electrostatic destruction) of the light-shielding film 23 is suppressed when at least the interface LG is located at the second portion 52. For example, the control apparatus 5 may apply a voltage to one or both of the light-shielding film 23 and the liquid immersion member 4 so that the deterioration (electrostatic destruction) of the light-shielding film 23 caused by the potential difference between the light-shielding film 23 and the liquid immersion member 4 is suppressed.

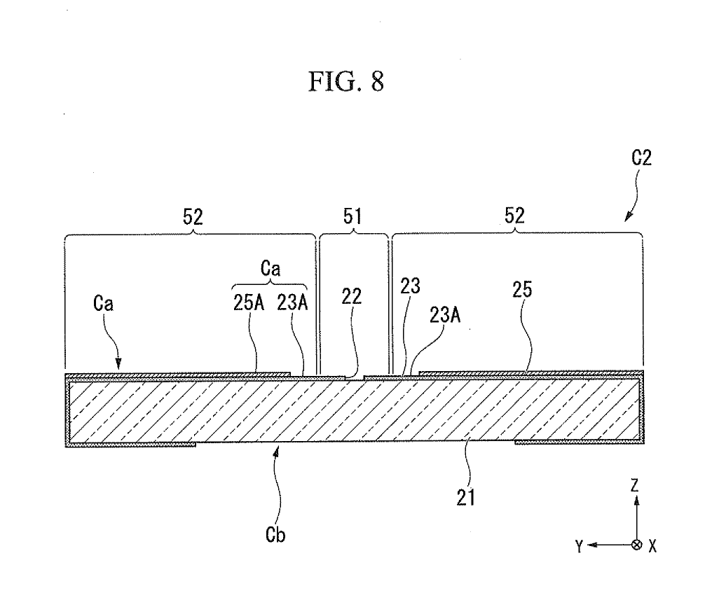

In addition, in the above-mentioned first and second embodiments, the measurement member C includes the light-shielding film 23, the insulating film 24, and the liquid-repellent film 25 on the base material 21, but the insulating film 24 may be omitted, for example, as shown in FIG. 8. A measurement member C2 shown in FIG. 8 includes the base material 21, the conductive light-shielding film 23, disposed on the base material 21, which defines the opening 22, and the liquid-repellent film 25 that covers at least a portion of the light-shielding film 23. The liquid-repellent film 25 is more liquid-repellent to the liquid LQ than the light-shielding film 23. The liquid-repellent film 25 is disposed in at least a portion of the periphery of the opening 22, in the upper surface 23A of the light-shielding film 23.

The upper surface Ca of the measurement member C2 includes the upper surface 23A of the light-shielding film 23 and the upper surface 25A of the liquid-repellent film 25. The first portion 51 of the upper surface Ca of the measurement member C2 includes the upper surface 23A of the light-shielding film 23, and the second portion 52 of the upper surface Ca includes the upper surface 25A of the liquid-repellent film 25. In addition, in the present embodiment, the second portion 52 includes at least a portion of the upper surface 23A of the light-shielding film 23. The exposure light EL is incident on the light-shielding film 23 without going through the liquid-repellent film 25.

Even when the measurement member C2 is used, it is possible to suppress the deterioration of the light-shielding film 23 by applying a voltage to at least one of the light-shielding film 23 of the measurement member C2 and the liquid immersion member 4, in accordance with the methods described in the above-mentioned first and second embodiments.

In addition, in the above-mentioned first and second embodiments, a voltage may be applied to at least one of the light-shielding film 23 and the liquid immersion member 4 in at least a portion of the period of time when the light-shielding film 23 is not irradiated with the exposure light EL, and a voltage may be applied to at least one of the liquid immersion member 4 and the light-shielding film 23 concurrently with at least a portion of the irradiation of the light-shielding film 23 with the exposure light EL. When a voltage is applied to at last one of the light-shielding film, 23 and the liquid immersion member 4 concurrently with the irradiation of the light-shielding film 23 with the exposure light EL, a voltage applied to at least one of the light-shielding film 23 and the liquid immersion member 4 may be determined so that emission of photoelectrons from the light-shielding film 23 is suppressed by the irradiation of the light-shielding film 23 with the exposure light EL. For example, a positive voltage may be applied to the light-shielding film 23 so that emission of photoelectrons from the light-shielding film 23 is suppressed while suppressing the above-mentioned electrostatic destruction.

### Third Embodiment

In the following description, the same reference signs and numerals are given to the same components as those of the above-mentioned embodiment, and the description will be simplified or omitted.

A third embodiment will be described below. The exposure apparatus EX according to the present embodiment is a liquid immersion exposure apparatus that exposes the substrate P with the exposure light EL through the liquid LQ, similarly to the liquid immersion exposure apparatus shown in FIG. 1 of the first embodiment.

Similarly to the exposure apparatus EX according to the first embodiment, the exposure apparatus EX according to the present embodiment includes a mask stage 1 that is movable while holding a mask M, a substrate stage 2 that is movable while holding the substrate P, a measurement stage 3 that is movable while holding a measurement member C and not holding the substrate P, an illumination system IL that illuminates the mask M with the exposure light EL, a projection optical system PL that projects an image of a pattern of the mask M, illuminated with the exposure light EL, onto the substrate P, a liquid immersion member 4 which is capable of forming a liquid immersion space LS so that a light path of the exposure light EL emitted from the projection optical system PL is filled with the liquid LQ, and a control apparatus 5 that controls a operation of the entire exposure apparatus EX.

In addition, the measurement member C according to the present embodiment is also the measurement member C similar to FIG. 2 of the first embodiment.

In addition, the substrate stage 2 and the measurement stage 3 according to the present embodiment have the same configuration as that shown in FIG. 3 of the first embodiment. In addition, the cross-sectional side view showing the vicinity of the measurement member C held in the holding portion 13 according to the present embodiment is also the same as the configuration shown in FIG. 4 of the first embodiment.

Next, an example of a measurement process using the measurement member C of the present embodiment will be described with reference to FIG. 4 of the first embodiment. When the measurement process using the measurement member C is performed, the control apparatus 5 disposes the measurement member C in the position facing the emission surface 9. The liquid LQ supplied from the supply port 33 is held between the emission surface 9, and the lower surface 32 and the measurement member C, and thus the liquid immersion space LS is formed. The liquid LQ of the liquid immersion space LS comes into contact with the emission surface 9, the lower surface 32, and the upper surface Ca.

In order to measure an space image (imaging characteristic) of the projection optical system PL using the space image measurement system 18 including the measurement member C, the control apparatus 5 emits the exposure light EL from the illumination system IL, and illuminates a pattern for measurement disposed at the object plane side of the projection optical system PL. The exposure light EL with which the pattern for measurement is irradiated and which passes through the projection optical system PL is emitted from the emission surface 9. At least a portion of the light-shielding film 23 of the measurement member C is irradiated with the exposure light EL emitted from the emission surface 9 through the liquid LQ of the liquid immersion space LS. In the present embodiment, the light-shielding film 23 is irradiated with the exposure light EL emitted from the emission surface 9 through the liquid LQ of the liquid immersion space LS and the insulating film 24.

In the present embodiment, the exposure light EL emitted from the emission surface 9 is incident on the first portion 51 in the upper surface Ca of the measurement member C, and is not incident on the second portion 52. That is, the insulating film 24 and the light-shielding film 23 are irradiated with the exposure light EL, and the liquid-repellent film 25 is not irradiated. In other words, the exposure light EL is incident on the light-shielding film 23 without going through the liquid-repellent film 25.

At least a portion of the exposure light EL with which the first portion 51 is irradiated is incident on the opening 22. The exposure light EL which is incident on the opening 22 through the liquid LQ passes through the base material, 21, and is emitted from the lower surface 21B. In the present embodiment, an optical element 38 of the space image measurement system 18 is disposed so as to come into contact with the lower surface 21B. The exposure light EL, emitted from the lower surface 21B, which passes through the optical element 38 is received in a light receiving element 39 of the space image measurement system 18. The control apparatus 5 seeks a space image (imaging characteristic) of the projection optical system PL through the liquid LQ, based on the light receiving result of the light receiving element 39.

When the light-shielding film 23 is irradiated with the exposure light EL, there is a possibility that a phenomenon (external photoelectric effect) in which photoelectrons are emitted from the light-shielding film 23 is generated, and the light-shielding film 23 is charged.

When a state in which the light-shielding film 23 is charged is left as it is, there is a possibility of at least a portion of the light-shielding film 23 being damaged due to, for example, electrical discharge. There is a possibility of the light-shielding film 23 being deteriorated, such as, for example, a case where the shape of the opening 22 changes, or a case where light transmission holes are present in a portion of the light-shielding film 23. As a result, there is a possibility of the accuracy of measurement using the measurement member C being reduced.

In addition, when photoelectrons are emitted from the light-shielding film 23, there is a possibility that at least one of the light-shielding film 23 and another film which comes into contact with the light-shielding film 23 is deteriorated (degenerated).

The present inventor has learned that deterioration of at least one of the light-shielding film 23 and another film which comes into contact with the light-shielding film 23 is suppressed by applying a voltage to the light-shielding film 23. For example, the present inventor has learned that deterioration of the light-shielding film 23 is suppressed by applying a voltage, determined based on photon energy by of the exposure light EL with which the light-shielding film 23 is irradiated and work function W of the light-shielding film 23, to the light-shielding film 23.

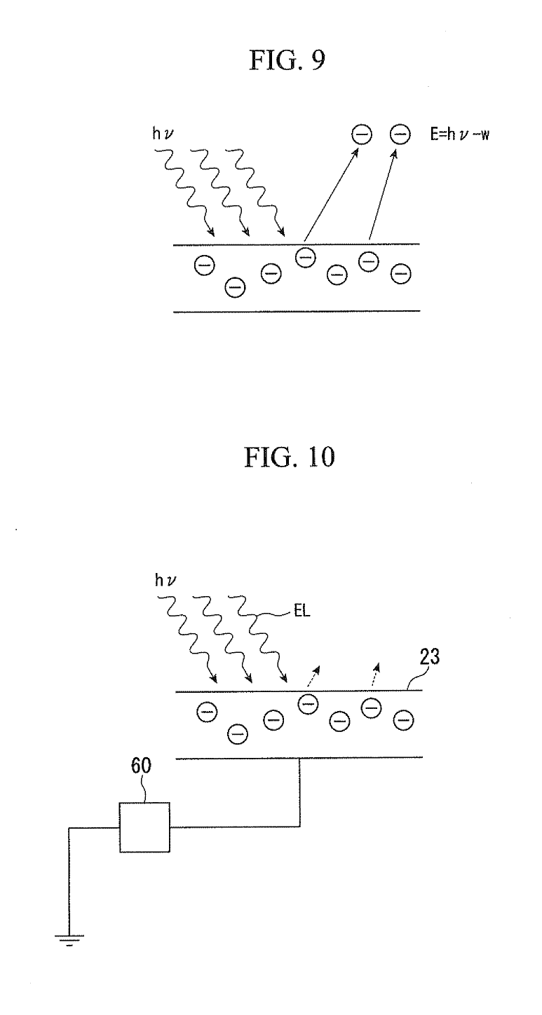

FIG. 9 is a schematic diagram illustrating an example of an external photoelectric effect when the surface of a metallic object is irradiated with light. When a metallic object is irradiated with light of photon energy hv, there is a possibility that a phenomenon (external photoelectric effect) in which photoelectrons are emitted from the object is generated. Energy E of the emitted photoelectrons is expressed by the following expression.

E=hv−W (1)

Where, h is a Planck's constant, v is a frequency of light with which the object is irradiated, and W is a work function of the object.

FIG. 10 is a schematic diagram illustrating an example of the light-shielding film 23 according to the present embodiment. The light-shielding film 23 is connected to the voltage adjustment apparatus 60. In the present embodiment, the voltage adjustment apparatus 60 applies a voltage to the light-shielding film 23 so that emission of photoelectrons from the light-shielding film 23 caused by the exposure light EL irradiation is suppressed.

In the present embodiment, the voltage adjustment apparatus 60 applies a voltage, determined based on photon energy hv of the exposure light EL with which the light-shielding film 23 is irradiated and work function W of the light-shielding film 23, to the light-shielding film 23. For example, the voltage adjustment apparatus 60 applies a voltage to the light-shielding film 23 so that emission of photoelectrons from the light-shielding film 23 by the external photoelectric effect based on the exposure light EL irradiation is suppressed. For example, the voltage adjustment apparatus 60 may apply a voltage of energy E (=hv−W) or more of photoelectrons to the light-shielding film 23, and may apply a voltage of less than energy E (=hv−W) of photoelectrons to the light-shielding film 23.

For example, when photon energy hv of the exposure light EL (ArF excimer laser light) is 6.43 [eV], and work function W of the light-shielding film 23 (chrome) is 4.5 [eV], energy E (=hv−W) of photoelectrons emitted from the light-shielding film 23 is 1.93 [eV]. The voltage adjustment apparatus 60 applies a voltage of, for example, energy E or more of photoelectrons to the light-shielding film 23. The voltage adjustment apparatus 60 applies a voltage of, for example, 1.95 [eV] to the light-shielding film 23. Thereby, even when the light-shielding film 23 is irradiated with the exposure light EL, emission of photoelectrons from the light-shielding film 23 is suppressed. In addition, even when a voltage of, for example, less than the energy E of the photoelectrons is applied to the light-shielding film 23, emission of photoelectrons from the light-shielding film 23 is suppressed.

Because of the emission of photoelectrons from the light-shielding film 23 is suppressed, charging of the light-shielding film 23 is suppressed. Thereby, the deterioration of the light-shielding film 23 and the film (in the present embodiment, the insulating film 24) which comes into contact with the light-shielding film 23 is suppressed, and a decrease in the accuracy of measurement using the measurement member C is suppressed.

In the present embodiment, the voltage adjustment apparatus 60 applies a voltage to the light-shielding film 23 concurrently with at least a portion of the irradiation of the light-shielding film 23 with the exposure light EL. In the present embodiment, when the light-shielding film 23 is irradiated with the exposure light EL, the voltage adjustment apparatus 60 applies a voltage to the light shielding film 23. In addition, the voltage adjustment apparatus 60 may apply a voltage to the light-shielding film 23 in a portion of the period of time when the light-shielding film 23 is irradiated with the exposure light EL.

In the present embodiment, when the light-shielding film 23 is not irradiated with the exposure light EL, the voltage adjustment apparatus 60 does not apply a voltage to the light-shielding film 23. In addition, the voltage adjustment apparatus 60 may apply a voltage to the light-shielding film 23 in a portion of the period of time when the light-shielding film 23 is not irradiated with the exposure light EL.

Next, a description will be given for an example of the operation of the exposure apparatus EX including a liquid immersion exposure process of the substrate P.

After the opening 22 of the measurement member C is irradiated with the exposure light EL and the measurement using the measurement member C is terminated, the control apparatus 5 starts an exposure of the substrate P. The control apparatus 5 illuminates the mask M with the exposure light EL emitted from the illumination system IL, in the state where the liquid immersion space LS is formed so that the light path of the exposure light EL between the last optical element 10 and the substrate P is filled with the liquid LQ. The exposure light EL through the mask M illuminates the projection optical system PL and the liquid LQ of the liquid immersion space LS. The exposure light EL passing through the mask M and the projection optical system PL is emitted from the emission surface 9. The substrate P is irradiated with the exposure light EL emitted from the emission surface 9 through the liquid LQ of the liquid immersion space LS. Thereby, an image of a pattern of the mask M is projected onto the substrate P, and the substrate P is exposed with the exposure light EL.

The exposure apparatus EX according to the present embodiment is a scanning-type exposure apparatus (so-called scanning stepper) that projects an image of a pattern of the mask M onto the substrate P while synchronously moving the mask M and the substrate P in a predetermined scanning direction. In the present embodiment, the scanning direction (synchronous movement direction) of the substrate P is a Y-axis direction, and the scanning direction (synchronous movement direction) of the mask M is also a Y-axis direction. The control apparatus 5 irradiates the substrate P with the exposure light EL through the projection optical system PL and the liquid LQ to expose the substrate P, while moving the substrate P in the Y-axis direction with respect to the projection region PR of the projection optical system PL, and moving the mask M in the Y-axis direction with respect to the illumination region IR of the illumination system IL in synchronization with the movement of the substrate P in the Y-axis direction.

In the present embodiment, the control apparatus 5 exposes the substrate P through the liquid LQ of the liquid immersion space LS formed at the emission surface 9 side, based on the measurement result using the measurement member C. For example, the control apparatus 5 adjusts exposure conditions based on the measurement result of the space image of the projection optical system PL measured using the measurement member C, and exposes the substrate P in the adjusted exposure conditions. The exposure conditions include, for example, at least one of irradiation conditions of the exposure light EL and the movement conditions of the substrate stage 2 (substrate P) for the projection region PR.

As described above, according to the present embodiment, since a voltage is applied to the light-shielding film 23 so that emission of photoelectrons from the light-shielding film 23 caused by the exposure light EL irradiation is suppressed, it is possible to suppress the deterioration of at least one of the light-shielding film 23 and the insulating film 24, a change in the shape of the opening 22 defined by the light-shielding film 23, or the like. Therefore, it is possible to suppress a decrease in the accuracy of measurement using the measurement member C, and to suppress the generation of a defective exposure and the generation of a defective device.

In addition, as shown in FIG. 3 of the first embodiment, a voltage may be applied to measurement members Cb and Cc disposed in the measurement stage 3. In the present embodiment, the measurement member Cb constitutes a portion of an illuminance unevenness measurement system 19 capable of measuring illuminance unevenness of the exposure light EL as disclosed in, for example, the U.S. Pat. No. 4,465,368 and the like. The measurement member Cc has a reference mark measured by an alignment system 20 capable of measuring an alignment mark of the substrate P as disclosed in, for example, the U.S. Pat. No. 5,493,403 and the like. In addition, the measurement member Cb may constitute a portion of a measurement system that measures the exposure light EL of the exposure light EL, such as an irradiance level measurement system (illuminance intensity measurement system) as disclosed in for example, the U.S. Patent Application Publication No. 2002/0,061,469 and the like, and a wavefront aberration measurement system as disclosed in, for example, the EP Patent No. 1,079,223 and the like.

In the present embodiment, the shape of the measurement member Cb within the XY plane is substantially circular. The measurement member Cb includes a base material capable of transmitting the exposure light EL, and a conductive light-shielding film 41 defining an opening 40, formed in the base material, on which the exposure light EL can be incident through the liquid LQ. In the present embodiment, the opening 40 is substantially circular. It is possible to suppress the deterioration of the light-shielding film 41, the deformation of the opening 40 and the like by applying a voltage to the light-shielding film 23 in accordance with the photon energy of the exposure light EL with which the light-shielding film 23 is irradiated and the work function of the light-shielding film 23.

In addition, in the above-mentioned embodiment, the voltage adjustment apparatus 60 may apply a voltage to the light-shielding film 23 based on the potential of the liquid immersion member 4 facing the measurement member C so that emission of photoelectrons from the light-shielding film 23 caused by the exposure light EL irradiation is suppressed. The voltage adjustment apparatus 60 may apply a voltage, determined based on the potential difference between the light-shielding film 23 and the liquid immersion member 4, to the light-shielding film 23 so that emission of photoelectrons from the light-shielding film 23 is suppressed.

In addition, in the above-mentioned embodiment, the liquid immersion member 4 may not be grounded.

In addition, in the above-mentioned embodiment, a voltage may be applied to the light-shielding film 23 so that emission of photoelectrons from the light-shielding film 23 is suppressed, in consideration of the potential difference between another member different from the liquid immersion member 4 and the light-shielding film 23.

### Fourth Embodiment

Next, a fourth embodiment will be described. In the following description, the same reference signs and numerals are given to the same components as those of the above-mentioned embodiment, and the description will be simplified or omitted.

In the present embodiment, art example will be described in which a voltage adjustment apparatus 70 applies a voltage to the liquid immersion member 4. The liquid immersion member 4 is conductive. At least a portion of the liquid immersion member 4 is made of metal, for example, such as titanium.

An example of the exposure apparatus EX according to the fourth embodiment is the same as the diagram shown in FIG. 7 of the first embodiment. The exposure apparatus EX according to the fourth embodiment includes the voltage system 700 that applies a voltage to the liquid immersion member 4, similarly to the exposure apparatus EX according to the first embodiment. The voltage system 700 includes the voltage adjustment apparatus 70 and the interconnection 71 connected to the voltage adjustment apparatus 70.

The voltage adjustment apparatus 70 includes a power supply 70A, a first adjustment portion 7013 capable of adjusting a value of a voltage applied to the liquid immersion member 4, a second adjustment portion 70C capable of adjusting a voltage applied to an object to at least one of positive and negative polarities, and a third adjustment portion 70D capable of adjusting a voltage (DC voltage) applied to the object.

The voltage adjustment apparatus 70 is disposed at the outside of the liquid immersion member 4. The voltage adjustment apparatus 70 is earthed (grounded). The voltage adjustment apparatus 70 applies a voltage to the liquid immersion member 4 through the interconnection 71. The voltage adjustment apparatus 70 applies a DC voltage to the liquid immersion member 4.

In the present embodiment, the light-shielding film 23 is earthed (grounded).

When the liquid immersion member 4 and the measurement member C face each other, the voltage adjustment apparatus 70 applies a voltage to the liquid immersion member 4. In addition, when the liquid immersion member 4 and the measurement member C do not face each other, the voltage adjustment apparatus 70 may apply a voltage to the liquid immersion member 4.

The voltage adjustment apparatus 70 applies a voltage to the liquid immersion member 4 so that emission of photoelectrons from the light-shielding film 23 caused by the exposure light EL irradiation is suppressed.

In the present embodiment, the voltage adjustment apparatus 70 applies a voltage to the liquid immersion member 4 based on the potential of the light-shielding film 23 facing the liquid immersion member 4 so that emission of photoelectrons from the light-shielding film 23 caused by the exposure light EL irradiation is suppressed. As mentioned above, in the present embodiment, the light-shielding film 23 is grounded. The voltage adjustment apparatus 70 applies a voltage, determined based on the potential difference between the light-shielding film 23 and the liquid immersion member 4, to the liquid immersion member 4 so that emission of photoelectrons from the light-shielding film 23 is suppressed.

In the present embodiment, the voltage adjustment apparatus 70 applies a voltage, determined based on photon energy hv of the exposure light EL with which the light-shielding film 23 is irradiated and work function W of the light-shielding film 23, to the liquid immersion member 4. For example, the voltage adjustment apparatus 70 applies a voltage to the liquid immersion member 4 so that emission of photoelectrons from the light-shielding film 23 by the external photoelectric effect based on the exposure light EL irradiation is suppressed.

In addition, the voltage adjustment apparatus 70 may apply a voltage to the light-shielding film 23 concurrently with at least a portion of the irradiation of the light-shielding film 23 with the exposure light EL. For example, when the light-shielding film 23 is irradiated with the exposure light EL through the liquid LQ, a voltage is applied to the liquid immersion member 4 facing the upper surface Ca of the measurement member C, and thus emission of photoelectrons from the light-shielding film 23 by the external photoelectric effect is suppressed. For example, a voltage of energy E or more of photoelectrons is applied to the liquid immersion member 4, and thus emission of photoelectrons from the light-shielding film 23 is suppressed. In addition, a voltage of less than energy E of photoelectrons may be applied to the liquid immersion member 4.

In addition, in the present embodiment, a voltage is applied to the liquid immersion member 4, and the light-shielding film 23 is grounded, but may not be grounded. In addition, a voltage may be apply to the liquid immersion member 4 by the voltage adjustment apparatus 70, and additionally a voltage may be apply to the light-shielding film 23 by the voltage adjustment apparatus 60. The control apparatus 5 may control at least one of the voltage adjustment apparatus 60 and the voltage adjustment apparatus 70, and may adjust the potential difference between the light-shielding film 23 and the liquid immersion member 4 so that emission, of photoelectrons from the light-shielding film 23 caused by the exposure light EL irradiation is suppressed. That is, the control apparatus 5 may apply a voltage to one or both of the light-shielding him 23 and the liquid immersion member 4 so that emission of photoelectrons from the light-shielding film 23 can be suppressed by the potential difference between the light-shielding film 23 and the liquid immersion member 4.

In addition, in the present embodiment, emission of photoelectrons from the light-shielding film 23 may be suppressed by applying a voltage to a member different from the liquid immersion member 4. In this case, a combination may be made with at least one of the application of a voltage to the liquid immersion member 4 and the application of a voltage to the light-shielding film 23.

In addition, in the above-mentioned first and second embodiments, the measurement member C includes the light-shielding film 23, the insulating film 24, and the liquid-repellent film 25 on the base material 21, but the insulating film 24 may be omitted, for example, as shown in FIG. 8 of the first embodiment. A measurement member C2 shown in FIG. 8 includes the base material 21, the conductive light-shielding film 23, disposed on the base material 21, which defines the opening 22, and the liquid-repellent film 25 that covers at least a portion of the light-shielding film 23. The liquid-repellent film 25 is more liquid-repellent to the liquid LQ than the light-shielding film 23. The liquid-repellent film 25 is disposed in at least a portion of the periphery of the opening 22, in the upper surface 23A of the light-shielding film 23.

The upper surface Ca of the measurement member C2 includes the upper surface 23A of the light-shielding film 23 and the upper surface 25A of the liquid-repellent film 25. The first portion 51 of the upper surface Ca of the measurement member C2 includes the upper surface 23A of the light-shielding film 23, and the second portion 52 of the upper surface Ca includes the upper surface 25A of the liquid-repellent film 25. In addition, in the present embodiment, the second portion 52 includes at least a portion of the upper surface 23A of the light-shielding film 23. The exposure light EL is incident on the light-shielding film 23 without going through the liquid-repellent film 25.

Even when the measurement member C2 is used, it is possible to suppress the deterioration of the light-shielding film 23 by applying a voltage to one or both of the light-shielding film 23 of the measurement member C2 and the liquid immersion member 4, in accordance with the methods described in the above-mentioned first and second embodiments.

In addition, in each of the above-mentioned embodiments, the measurement member (C or the like) is mounted on the measurement stage 3, but may be mounted on the movement member different from the measurement stage 3 which is movable with respect to the last optical element 10. For example, the measurement member C may be mounted on the substrate stage 2. The movement member including the substrate stage 2 and the like moves, and thus the measurement member C can be disposed at a position (projection region PR) which is capable of being irradiated with the exposure light EL emitted from the emission surface 9. In addition, when a plurality of measurement members are provided, some measurement members may be mounted on the substrate stage 2, and some measurement members may be mounted on the measurement stage 3. In addition, the measurement member C may be mounted on a movement member different from the substrate stage 2 and the measurement stage 3. In addition, an interconnection connected to the voltage adjustment apparatus 60 may be included the movement member, and the entire movement member may be an electric conductor.

In addition, in each of the present embodiments mentioned above, although the light path on the emission side (image plane side) of the last optical element 10 of the projection optical system PL is filled with the exposure liquid LQ, it is possible to adopt the projection optical system PL in which the light path, on the incident side (object plane side) of the last optical element 10 is also filled with the exposure liquid LQ, for example, as disclosed in the International Publication No. 2004/019,128.

In addition, in each of the above-mentioned embodiments, although water is used as the liquid LQ, the liquid other than water may be used. It is preferable that the liquid LQ is transmissive to the exposure light EL, has a high refractive index with respect to the exposure light EL, and is stable with respect to a film such as a photosensitive material (photoresist) of which the projection optical system PL or the surface of the substrate P is formed. For example, fluorine liquid such as hydrofluoroether (HFE), perfluorinated polyether (PFPE), and fomblin (registered trademark) oil can also be used as the liquid LQ. In addition, various fluids, for example, a supercritical fluid can also be used as the liquid LQ.

In addition, as the substrate P of each of the above-mentioned embodiments, not only a semiconductor wafer for a semiconductor device, but also a glass substrate for a display device, a ceramic wafer for a thin-film magnetic head, or an original plate (synthetic silica, silicon wafer) of a mask or a reticle used in the exposure apparatus and the like are applied.

The exposure apparatus EX can also applied to a step-and-repeat type projection exposure apparatus (stepper) in which the sequential step movement is performed on the substrate P by collectively exposing the patterns of the mask M in the state where the mask M and the substrate P are stopped, in addition to a step-and-scan type scanning exposure apparatus (scanning stepper) that scans and exposes the pattern of the mask M by synchronously moving the mask M and the substrate P.

Further, in the step-and-repeat type exposure, after a reduced image of a first pattern is transferred onto the substrate P using the projection optical system in the state where the first pattern and the substrate P are substantially stopped, a reduced image of a second pattern may be partially overlapped with the first pattern using the projection optical system to perform collective exposure onto the substrate P in the state where the second pattern and the substrate P are substantially stopped (stitch-type collective exposure apparatus). In addition, the stitch-type exposure apparatus can also be applied to a step-and-stitch type exposure apparatus which, partially overlaps at least two patterns with each other on the substrate P to transfer them, and sequentially moves the substrate P.

In addition, for example, as disclosed in the U.S. Pat. No. 6,611,316, the present invention can also be applied to an exposure apparatus which synthesizes patterns of two masks on the substrate through the projection optical system, and almost simultaneously double-exposes one shot region on the substrate by one-time scanning exposure. In addition, the present invention cm also be applied to a proximity-type exposure apparatus, a mirror projection aligner and the like.

In addition, the exposure apparatus EX may be a twin stage type exposure apparatus which includes a plurality of substrate stages without a measurement stage, as disclosed in the U.S. Pat. No. 6,341,007, the U.S. Pat. No. 6,208,407, the U.S. Pat. No. 6,262,796 and the like.

The type of exposure apparatus EX is also not limited to a semiconductor device fabrication exposure apparatus that exposes the pattern of a semiconductor device on the substrate P, but can be widely adapted to exposure apparatuses that are used for fabricating, for example, liquid crystal devices or displays, and exposure apparatuses that are used for manufacturing thin film magnetic heads, image capturing devices (CCDs), micro-machines, MEMS, DNA chips, reticles or masks, and the like.

In addition, in each of the present embodiments mentioned above, the position of each of the stages is measured using an interferometer system that comprises laser interferometers, but the present invention is not limited thereto; for example, an encoder system that detects a scale (diffraction grating) provided to each of the stages may be used.

In addition, in the above-mentioned embodiments, an optically transmissive mask wherein a prescribed shielding pattern (or phase pattern, or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, the U.S. Pat. No. 6,778,257, may be used. In addition, instead of a variable shaped mask that comprises anon-emissive type image display device, a pattern forming apparatus that comprises a self-luminous type image display device may be provided.

In each of the above-mentioned embodiments, although the exposure apparatus that includes the projection optical system PL has been, described by way of example, but the present invention can be applied to an exposure apparatus and an exposing method that do not use the projection optical system PL. For example, the immersion space can be formed between an optical member such as a lens and the substrate, and the substrate can be radiated with the exposure light through the optical member.

In addition, the present invention can also be applied to an exposure apparatus (lithographic system) that, by forming interference fringes on the substrate P, exposes the substrate P with a line-and-space pattern, as disclosed in, for example, PCT International Publication No. WO2001/035,168.

The exposure apparatus EX according to the above-mentioned embodiments is manufactured by assembling various subsystems, including each of the components, so that predetermined mechanical, electrical, and optical accuracies are maintained. To ensure these various accuracies, adjustments axe performed before and after this assembly, including an adjustment to achieve optical accuracy for the various optical systems, an adjustment to achieve the mechanical accuracy for the various mechanical systems, and an adjustment to achieve the electrical accuracy for the various electrical systems. The process of assembling the exposure apparatus from the various subsystems includes, for example, the connection of mechanical components, the wiring and connection of electrical circuits, and the piping and connection of the pneumatic circuits among the various subsystems. Naturally, prior to performing the process of assembling the exposure apparatus from these various subsystems, there are also processes of assembling each individual subsystem. When the process of assembling the exposure apparatus from the various subsystems is complete, a comprehensive adjustment is performed to ensure the various accuracies of the exposure apparatus as a whole. In addition, it is preferable to manufacture the exposure apparatus in a clean room in which, for example, the temperature and the cleanliness level are controlled.

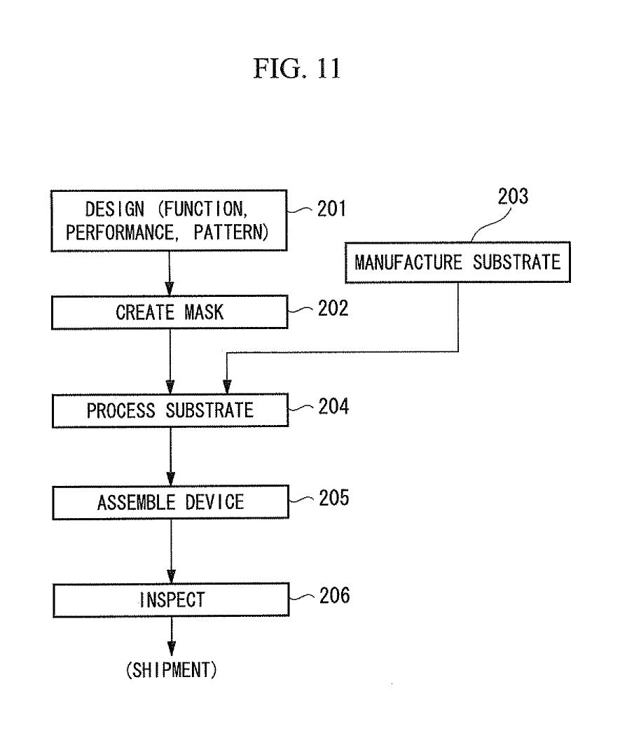

As shown in FIG. 11, a micro-device, such as a semiconductor device, is manufactured by a step 201 of designing the functions and performance of the micro-device, a step 202 of manufacturing the mask (reticle) based on this designing step, a step 203 of manufacturing the substrate P, which is the base material of the device, a substrate processing step 204 of a substrate process (exposure process) that includes, in accordance with the embodiments mentioned above, exposing the substrate P with the exposure light EL that emits from the pattern of the mask M and developing the exposed substrate P, a device assembling step 205 (which includes fabrication processes such as dicing, bonding, and packaging processes), an inspecting step 206, and the like.

In addition, the features of each of the embodiments mentioned above can be combined as appropriate. In addition, there may be cases in which some of the components are not used. In addition, each disclosure of every Japanese published patent application and U.S. patent related to the exposure apparatus recited in each of the embodiments, modified examples, and the like discussed above is hereby incorporated by reference in its entirety to the extent permitted by national laws and regulations.

1. An exposure apparatus that exposes a substrate with exposure light through liquid, comprising:
an optical member which has an emission surface from which the exposure light is emitted, and in which a liquid immersion space of the liquid is formed at the emission surface side;
a measurement member that has a conductive first film and an upper surface, the conductive first film being irradiated with measurement light, the upper surface comprising a first portion and a second portion, the first portion being capable of facing the emission surface and being irradiated with measurement light, and the second portion comprising a surface of a third film which is disposed in at least a portion of a periphery of the first portion and which is more liquid-repellent to the liquid than the first film;
a liquid immersion member which is disposed so as to be capable of facing the measurement member in at least a portion of a periphery of the optical member and which is capable of holding liquid in between with the measurement member; and
a voltage adjustment apparatus that applies a voltage to at least one of the first film and the liquid immersion member, when at least a portion of an interface of the liquid of the liquid immersion space is located at the second portion.

2. The exposure apparatus according to claim 1, wherein the voltage adjustment apparatus applies the voltage when the measurement member moves in a state where at least a portion of the interface is located at the second portion.

3. The exposure apparatus according to claim 2, wherein the voltage adjustment apparatus applies a first voltage when the measurement member moves in a first movement condition, and applies a second voltage when the measurement member moves in a second movement condition.

4. The exposure apparatus according to claim 3, wherein the interface moves from the second portion to the first portion in the first movement condition, and the interface moves from the first portion to the second portion in the second movement condition.

5. The exposure apparatus according to claim 3, wherein a movement velocity of the measurement member in the first movement condition is different from a movement velocity of the measurement member in the second movement condition.

6. The exposure apparatus according to claim 3, wherein the first voltage and the second voltage are different from each other in polarity.

7. The exposure apparatus according to claim 3, wherein the first voltage and the second voltage are different from each other in magnitude.

8. The exposure apparatus according to claim 1, further comprising a supply port that supplies the liquid between the optical member and the measurement member.

9. The exposure apparatus according to claim 1, wherein at least a portion of the first portion comprises a surface of the first film.

10. The exposure apparatus according to claim 1, wherein the measurement member has an insulating second film that covers at least a portion of the first film, and
at least a portion of the first portion comprises a surface of the second film.

11. The exposure apparatus according to claim 1, wherein the third film comprises fluorine.

12. The exposure apparatus according to claim 1, wherein the voltage adjustment apparatus is grounded.

13. The exposure apparatus according to claim 1, wherein the voltage adjustment apparatus applies a DC voltage.

14. An exposure apparatus that exposes a substrate with exposure light through liquid, comprising:
an optical member having an emission surface from which the exposure light is emitted;
a measurement member which is capable of being disposed at an area which is irradiated with the exposure light emitted from the emission surface, and which has a conductive first film and an insulating second film, the conductive first film being irradiated with measurement light and the insulating second film being disposed so as to cover at least a portion of the first film; and
a voltage adjustment apparatus that applies a voltage to the first film.

15. The exposure apparatus according to claim 14, wherein at least a portion of an upper surface of the measurement member which is capable of facing the emission surface includes a surface of the first film.

16. The exposure apparatus according to claim 14, wherein at least a portion of an upper surface of the measurement member which is capable of facing the emission surface includes a surface of the second film, and
the first film is irradiated with the measurement light through the second film.

17. The exposure apparatus according to claim 14, wherein the upper surface of the measurement member which is capable of facing the emission surface comprises a surface of a third film, the surface of the third film covers at least a portion of the second film and is more liquid-repellent to the liquid than the first film.

18. The exposure apparatus according to claim 14, wherein the upper surface of the measurement member which is capable of facing the emission surface comprises a third film, the third film covers at least a portion of the first film and is more liquid-repellent to the liquid than the first film.

19. The exposure apparatus according to claim 17, wherein the measurement light is incident on the first film without going through the third film.

20. The exposure apparatus according to claim 17, wherein the third film comprises fluorine.

21. The exposure apparatus according to claim 14, further comprising a supply port that supplies the liquid onto the measurement member,
wherein the measurement member is irradiated with the measurement light through the liquid.

22. The exposure apparatus according to claim 14, wherein the voltage adjustment apparatus applies the voltage concurrently with at least a portion of irradiation of the first film with the measurement light.

23. The exposure apparatus according to claim 14, wherein the voltage adjustment apparatus is grounded.

24. The exposure apparatus according to claim 14, wherein the voltage adjustment apparatus applies a DC voltage.

25. The exposure apparatus according to claim 14, further comprising:
a liquid immersion member, which is disposed so as to be capable of facing the measurement member in at least a portion of the periphery of the optical member and is capable of holding liquid in between with the measurement member; and
a second voltage adjustment apparatus that applies a voltage to the liquid immersion member.

26. An exposure apparatus that exposes a substrate with exposure light through liquid, comprising:
an optical member which has an emission surface from which the exposure light is emitted, and in which a liquid immersion space of the liquid is formed at the emission surface side;
a measurement member having a conductive first film which is irradiated with measurement light;
a liquid immersion member which is disposed so as to be capable of facing the measurement member in at least a portion of the periphery of the optical member and which is capable of holding liquid in between with the measurement member; and
a voltage adjustment apparatus that applies a voltage to the liquid immersion member.

27. The exposure apparatus according to claim 26, further comprising a supply port that supplies the liquid onto the measurement member,
wherein the measurement member is irradiated with the measurement light through the liquid.

28. The exposure apparatus according to claim 26, wherein the voltage adjustment apparatus applies the voltage to the first film concurrently with at least a portion of irradiation of the first film with the measurement light.

29. The exposure apparatus according to claim 26, wherein at least a portion of an upper surface of the measurement member which is capable of facing the emission surface comprises a surface of the first film.

30. The exposure apparatus according to claim 26, wherein at least a portion of the upper surface of the measurement member which is capable of facing the emission surface comprises a surface of an insulating second film that covers the first film, and
the first film is irradiated with measurement light through the second film.

31. The exposure apparatus according to claim 30, wherein the upper surface comprises a surface of a third film which covers at least a portion of the second film and which is more liquid-repellent to the liquid than the first film.

32. The exposure apparatus according to claim 31, wherein the third film covers at least a portion of the first film.

33. The exposure apparatus according to claim 26, wherein at least a portion of the upper surface of the measurement member which is capable of facing the emission surface comprises a surface of a third film which is more liquid-repellent to the liquid than the first film, and
the third film covers at least a portion of the first film.

34. The exposure apparatus according to claim 31, wherein the first film is irradiated with the measurement light without going through the third film.

35. The exposure apparatus according to claim 31, wherein the third film comprises fluorine.

36. The exposure apparatus according to claim 1, further comprising a stage which is movable with respect to the optical member,
wherein the measurement member is disposed at the stage, and
at least a portion of the voltage adjustment apparatus is provided at the stage.

37. The exposure apparatus according to claim 1, wherein the first film comprises at least one of chrome, copper, platinum, and tantalum.

38. The exposure apparatus according to claim 1, wherein the first film comprises a light-shielding film.

39. The exposure apparatus according to claim 1, wherein the measurement light comprises the exposure light emitted from the emission surface.

40. A device manufacturing method comprising:
exposing a substrate using the exposure apparatus according to claim 1; and
developing the exposed substrate.

41. An exposure method of exposing a substrate with exposure light through liquid, comprising:
moving a measurement member with respect to an area which is irradiated with the exposure light emitted from an emission surface of an optical member from which the exposure light is emitted, the measurement member having a conductive first film and an upper surface, the conductive first film being irradiated with measurement light, the upper surface comprising a first portion and a second portion, the first portion being capable of facing the emission surface and being irradiated with the measurement light, and the second portion comprising a surface of a third film which is disposed in a periphery of the first portion and which is more liquid-repellent to the liquid than the first film;
applying a voltage to at least one of the first film and the liquid immersion member when at least a portion of an interface of liquid of a liquid immersion space is located at the second portion; and
exposing the substrate through the liquid immersion space of the liquid formed at the emission surface side, based on a result of the measurement using the measurement member.

42. An exposure method of exposing a substrate with exposure light through liquid, comprising:
irradiating a measurement light to a conductive first film of a measurement member which is capable of being disposed at an area which is irradiated with the exposure light emitted from an emission surface of an optical member, the measurement member having an insulating second film which is disposed so as to cover at least a portion of the first film;
applying a voltage to the first film; and
exposing the substrate through a liquid immersion space of the liquid which is formed at the emission surface side, based on a result of the measurement using the measurement member.

43. An exposure method of exposing a substrate with exposure light through liquid, comprising:
irradiating a measurement light to a conductive first film of a measurement member which is capable of being disposed at an area which is irradiated with the exposure light emitted from an emission surface of an optical member;
applying a voltage to a liquid immersion member which is disposed so as to be capable of facing the measurement member in at least a portion of a periphery of the optical member and which is capable of holding liquid in between with the measurement member; and
exposing the substrate through a liquid immersion space of the liquid which is formed at the emission surface side, based on a result of the measurement using the measurement member.

44. A device manufacturing method comprising:
exposing a substrate using the exposure method according to claim 41; and
developing the exposed substrate.

45. An exposure apparatus that exposes a substrate with exposure light through liquid, comprising:
an optical member which has an emission surface from which the exposure light is emitted, and under which a liquid immersion space of the liquid is formed at an emission surface side;
a measurement member which is capable of being disposed at an area which is irradiated with the exposure light emitted from the emission surface and which has a conductive first film which is irradiated with measurement light;
a liquid immersion member which is disposed so as to be capable of facing the measurement member in at least a portion of a periphery of the optical member and which is capable of holding liquid in between with the measurement member; and
a voltage adjustment apparatus that applies a voltage to at least one of the first film and the liquid immersion member so as to suppress emission of photoelectrons from the first film caused by the measurement light irradiation.

46. The exposure apparatus according to claim 45, wherein the voltage adjustment apparatus applies a voltage determined based on a potential difference between the first film in which the emission of photoelectrons is suppressed and the liquid immersion member.

47. The exposure apparatus according to claim 45, wherein the voltage adjustment apparatus applies a voltage determined based on photon energy of the measurement light with which the first film is irradiated and a work function of the first film.

48. The exposure apparatus according to claim 45, further comprising a supply port that supplies the liquid onto the measurement member,
wherein the first film of the measurement member is irradiated with the measurement light through the liquid.

49. The exposure apparatus according to claim 45, wherein the voltage adjustment apparatus applies the voltage concurrently with at least a portion of irradiation of the first film with the measurement light.

50. The exposure apparatus according to claim 45, wherein the measurement member has an upper surface which is capable of facing the emission surface, and
at least a portion of the upper surface comprises a surface of the first film.

51. The exposure apparatus according to claim 45, wherein the measurement member has an upper surface which is capable of facing the emission surface,
at least a portion of the upper surface comprises an insulating second film that covers at least a portion of the first film, and
the first film is irradiated with the measurement light through the second film.

52. The exposure apparatus according to claim 51, wherein the upper surface comprises a liquid-repellent third film that covers at least a portion of the second film.

53. The exposure apparatus according to claim 50, the upper surface comprises a liquid-repellent third film that covers at least a portion of the first film.

54. The exposure apparatus according to claim 52, wherein the upper surface of the measurement member comprises a first portion on which the measurement light is incident and a second portion around the first portion, and
the third film is disposed in at least a portion of the second portion.

55. The exposure apparatus according to claim 52, wherein the third film comprises fluorine.

56. The exposure apparatus according to claim 45, wherein the voltage adjustment apparatus is grounded.

57. The exposure apparatus according to claim 45, wherein the voltage adjustment apparatus applies a DC voltage.

58. The exposure apparatus according to claim 45, further comprising a stage which is movable with respect to the optical member,
wherein the measurement member is mounted on the stage, and
at least a portion of the voltage adjustment apparatus is provided at the stage.

59. The exposure apparatus according to claim 45, wherein the first film comprises at least one of chrome, copper, platinum, and tantalum.

60. The exposure apparatus according to claim 45, wherein the first film comprises a light-shielding film.

61. The exposure apparatus according to claim 45, wherein the measurement light comprises the exposure light emitted from the emission surface.

62. A device manufacturing method comprising:
exposing a substrate using the exposure apparatus according to claim 45; and
developing the exposed substrate.

63. A measurement method used in an exposure apparatus that exposes a substrate with exposure light through liquid, comprising:
irradiating a measurement light to a conductive first film of a measurement member which is capable of being disposed at an area which is irradiated with the exposure light emitted from an emission surface of an optical member; and
applying a voltage to at least one of a first film and a liquid immersion member so as to suppress emission of photoelectrons from the first film caused by the measurement light irradiation, the liquid immersion member being disposed so as to be capable of facing the measurement member in at least a portion of the periphery of the optical member and to be capable of holding liquid in between with the measurement member.

64. A device manufacturing method comprising:
exposing the substrate through a liquid immersion space of the liquid which is formed at the emission surface side, based on a result of the measurement using the measurement method according to claim 63; and
developing the exposed substrate.
